(19) United States
(12) Patent Application Publication
(10) Pub. No.: US 2023/0095801 A1
(43) Pub. Date: Mar. 30, 2023

(54) SOLID-STATE BATTERY, MULTILAYER STRUCTURE FOR A SOLID-STATE BATTERY, AND METHOD FOR MANUFACTURING A MULTILAYER STRUCTURE FOR A SOLID-STATE BATTERY

(71) Applicant: Ampcera Inc., Milpitas, CA (US)

(72) Inventors: Hui Du, Tucson, AZ (US); James Emery Brown, Tucson, AZ (US); Sumin Zhu, Phoenix, AZ (US)

(21) Appl. No.: 17/957,736

(22) Filed: Sep. 30, 2022

Related U.S. Application Data
(60) Provisional application No. 63/250,550, filed on Sep. 30, 2021.

(51) Int. Cl. H01M 10/0585; H01M 4/04; H01M 4/36

(52) U.S. Cl. CPC H01M 10/0585; H01M 4/0404; H01M 4/0407; H01M 4/366; H01M 2004/028

(57) ABSTRACT

A solid-state battery comprising: a positive current collector; a negative current collector; a solid state electrolyte layer between the positive current collector and the negative current collector; and at least one of a catholyte gradient composite cathode structure between the positive current collector and the solid state electrolyte layer and an anolyte gradient composite anode structure between the negative current collector and the solid state electrolyte layer.

### PRIORITY

The present application claims the priority of U.S. Provisional Patent Application No. 63/250,550, filed Sep. 30, 2021, which is incorporated herein by reference in its entirety.

### FIELD

The present application relates to the field of solid-state batteries, in particular lithium solid-state batteries.

### BACKGROUND

Achieving both high energy density and power density is critical for solid-state lithium batteries, especially in electric vehicle applications. However, achieving both has been a challenge, typically requiring undesirable tradeoffs.

### SUMMARY

In one embodiment, a solid-state battery comprises: a positive current collector; a negative current collector; a solid state electrolyte layer between the positive current collector and the negative current collector; and at least one of a catholyte gradient composite cathode structure between the positive current collector and the solid state electrolyte layer and an anolyte gradient composite anode structure between the negative current collector and the solid state electrolyte layer.

In another embodiment, a method for manufacturing a multilayer structure for a solid-state battery comprises: forming a first layer comprising a first catholyte or anolyte content; and forming a second layer on the first layer, the second layer comprising a second catholyte or anolyte content, wherein the first catholyte or anolyte content is different from the second catholyte or anolyte content.

In yet another embodiment, a multilayer structure for a solid-state battery comprises: a current collector; and a plurality of layers comprising a catholyte or anolyte content, wherein the plurality of layers has a catholyte gradient or an anolyte gradient with respect to adjacent layers of the plurality of layers.

Other embodiments of the disclosed solid-state batteries, multilayer structures, and methods for manufacturing will become apparent from the following detailed description, the accompanying drawings and the appended claims.

### BRIEF DESCRIPTION OF THE DRAWINGS

FIG. 1A: A schematic illustration of the present description of a first composite cathode layer formed onto a positive current collector, or alternatively, a first composite anode layer formed onto a negative current collector.

FIG. 1B: A schematic illustration of the present description of a second composite cathode layer formed onto the first composite cathode layer, or alternatively, a second composite anode layer formed onto the first composite anode layer.

FIG. 1C: A schematic illustration of the present description of a third composite cathode layer formed onto the second composite cathode layer, or alternatively, a third composite anode layer formed onto the second composite anode layer.

FIG. 1D: A schematic illustration of the present description of a solid-state electrolyte layer formed onto the third composite cathode layer, or alternatively, a solid-state electrolyte layer formed onto the third composite anode layer.

FIG. 1E: A schematic illustration of the present description of a first composite anode layer formed onto the solid-state electrolyte layer, or alternatively, a first composite cathode layer formed onto the solid-state electrolyte layer

FIG. 1F: A schematic illustration of the present description of a second composite anode layer formed onto the first composite anode layer, or alternatively, a second composite cathode layer formed onto the first composite cathode layer.

FIG. 1G: A schematic illustration of the present description of a first gradient solid-state battery layer, wherein a third composite anode layer is laminated with a negative current collector, the third composite anode layer is formed onto the second composite anode layer, or alternatively, wherein a third composite cathode layer is laminated with a positive current collector, the third composite cathode layer is formed onto the second composite cathode layer.

FIG. 2: A schematic illustration of the present description of a gradient solid-state battery layer that may be manufactured using a high-throughput spray process to form a densely layered structure.

FIG. 3A: A schematic illustration of the present description of a first gradient solid-state battery layer.

FIG. 3B: A schematic illustration of the present description of a second gradient solid-state battery layer, wherein the second layer is formed onto the backside of a positive current collector supporting the first gradient solid-state battery layer from FIG. 3A.

FIG. 3C: A schematic illustration of the present description of a second gradient solid-state battery layer, wherein the second layer is formed onto the top of the laminated negative current collector from FIG. 3A.

FIG. 4A: A schematic illustration of the present description of a first gradient solid-state battery layer.

FIG. 4B: A schematic illustration of the present description of a second gradient solid-state battery layer, wherein the second layer is formed onto the backside of the negative current collector supporting the first gradient solid-state battery layer from FIG. 4A.

FIG. 4C: A schematic illustration of the present description of a second gradient solid-state battery layer, wherein the second layer is formed onto the top of the laminated positive current collector from FIG. 4A.

FIG. 5A: A schematic illustration of the present description of a roll-to-roll solvent-based manufacturing method using a tape casting approach to construct a gradient solid-state battery layer.

FIG. 5B: A schematic illustration of the present description of a roll-to-roll solvent-based manufacturing method using a spraying approach to construct a gradient solid-state battery layer.

FIG. 5C: A schematic illustration of the present description of a roll-to-roll solvent-based manufacturing method using an ink jet printing approach to construct a gradient solid-state battery layer.

FIG. 5D: A schematic illustration (top) of the present description of a spray process using more than one shower head to form a first composite cathode or anode slurry layer onto a positive or negative current collector.

FIG. 6A: A schematic illustration of the present description of a roll-to-roll solvent-free manufacturing method using a cold or thermal spray approach to construct a gradient solid-state battery layer.

FIG. 6B: A schematic illustration of the present description of a cold or thermal spray process using more than one spray gun to form a first composite cathode or anode layer onto a positive or negative current collector.

FIG. 6C: A schematic illustration of the present description of a roll-to-roll solvent-free manufacturing method using a laser-assisted approach to construct a gradient solid-state battery layer.

FIG. 6D: A schematic illustration of the present description of a laser-assisted process using more than one powder nozzle and laser to form a first composite cathode or anode layer onto a positive or negative current collector.

### DETAILED DESCRIPTION

The present description relates to solid-state batteries, in particular solid-state lithium batteries, comprising of a gradient architecture, to methods for manufacturing the gradient architecture, including a solvent-based method for manufacturing the gradient architecture and a solvent-free method for manufacturing the gradient architecture. Hereinafter, the present description primarily references solid-state lithium batteries. However, many of the principles are application to other types of solid state batteries.

A solid-state lithium battery comprises of one or more gradient solid-state battery superstructures (also referred to herein as gradient solid-state battery layers), wherein a gradient solid-state battery layer comprises of at least one of (preferably both) a catholyte gradient composite cathode structure and an anolyte gradient composite anode structure. The catholyte gradient composite cathode structure and an anolyte gradient composite anode structure are separated by a solid-state electrolyte layer (e.g., a single solid-state electrolyte layer). Hereinafter, the present description primarily references single solid-state electrolyte layer. However, it would be understood that the additional solid-state electrolyte layers can be included.

The catholyte gradient composite cathode structure and the anolyte gradient composite anode structure (also referred to herein as gradient electrode structures) may be formed layer-by-layer using a solvent-based manufacturing approach or a solvent-free manufacturing approach to maximize power and energy densities and enhance battery safety. The gradient electrode structures may be formed layer-by-layer using a high-throughput solvent-free manufacturing approach to maximize power and energy densities and enhance battery safety.

Achieving both high energy density and power density is critical for solid-state lithium batteries, especially in electric vehicle applications. However, achieving both has been a challenge, typically requiring undesirable tradeoffs. One way to achieve this is to use composite electrodes with a gradient structure.

A solid-state lithium battery may be composed of one or more gradient solid-state battery layers. A gradient solid-state battery layer may be composed of a catholyte gradient composite cathode structure and an anolyte gradient composite anode structure, separated by a single solid-state electrolyte layer.

A catholyte gradient composite cathode structure can maximize contact between catholyte and active material (i.e., powder density) while maintaining a high active loading (i.e., energy density). In the gradient structure catholyte content may be low at the current collector and may be gradually increased toward the solid-state electrolyte interface. The high catholyte content at the outer surface of the composite cathode may reduce the interface impedance at the composite cathode/solid-state electrolyte interface enabling higher power-rates. The gradient structure may be constructed to facilitate and optimize lithium-ion conduction throughout the composite cathode.

An anolyte gradient composite anode structure can maximize contact between anolyte and active material (i.e., powder density) while maintaining a high active loading (i.e., energy density). In the gradient structure anolyte content may be low at the current collector and may be gradually increased toward the solid-state electrolyte interface. The high anolyte content at the outer surface of the composite anode may reduce the interface impedance at the composite anode/solid-state electrolyte interface enabling higher power-rates. The gradient structure may be constructed to facilitate and optimize lithium-ion conduction throughout the composite anode.

A single solid-state electrolyte layer may separate the catholyte and anolyte gradient structures. The solid-state electrolyte layer may comprise of the catholyte material, the anolyte material, an alternative solid-state ionic conductive material, or a combination thereof.

Gradient solid-state battery layers may be processed using a solvent-based processing method, wherein the gradient structure may be constructed layer by layer. Each gradient electrode layer may be formed using a specific composite cathode or composite anode formulation that may be tuned to optimize performance. A catholyte gradient composite cathode structure may first be formed onto a positive current collector followed by a single solid-state electrolyte layer, wherein an anolyte gradient composite anode structure may be formed onto the solid-state electrolyte layer in a reverse gradient order. Alternatively, an anolyte gradient composite anode structure may first be formed onto a negative current collector followed by a single solid-state electrolyte layer, wherein a catholyte gradient composite cathode structure may be formed onto the solid-state electrolyte in a reverse gradient order.

Gradient solid-state battery layers may be processed using a high-throughput solvent-free processing method, wherein the gradient structure may be constructed layer by layer. Each gradient electrode layer may be formed using a specific dry composite cathode or composite anode powder formulation that may be tuned to optimize performance. A catholyte gradient composite cathode structure may first be formed onto a positive current collector followed by a single solid-state electrolyte layer, wherein an anolyte gradient composite anode structure may be formed onto the solid-state electrolyte layer in a reverse gradient order. Alternatively, an anolyte gradient composite anode structure may first be formed onto a negative current collector followed by a single solid-state electrolyte layer, wherein a catholyte gradient composite cathode structure may be formed onto the solid-state electrolyte in a reverse gradient order. The dry processing approach may eliminate the conventional drying and hot calendering methods used in conventional battery electrode processing.

In an embodiment, a solid-state lithium battery may comprise of one or more gradient solid-state battery layers.

In an aspect of the embodiment, a gradient solid-state battery layer may be formed onto a positive current collector, such as aluminum foil, wherein a catholyte gradient composite cathode structure may be formed prior to the solid-state electrolyte layer and the anolyte gradient composite anode structure.

In another aspect of the embodiment, a gradient solid-state battery layer may be formed onto a negative current collector, such as copper foil, wherein an anolyte gradient composite anode structure may be formed prior to the solid-state electrolyte layer and the catholyte gradient composite cathode structure.

In yet another aspect of the embodiment, a gradient solid-state battery layer comprises of a single solid-state electrolyte layer separating the catholyte gradient composite cathode structure and anolyte gradient composite anode structure.

In another embodiment, a gradient solid-state battery layer may be composed of a catholyte gradient composite cathode structure as the positive electrode.

In an aspect of the embodiment, a catholyte may be defined as a solid-state ionic conducting material within the composite cathode structure.

In another aspect of the embodiment, a catholyte may be used in a solid-state lithium battery to facilitate ion conduction within the composite cathode structure.

In yet another aspect of the embodiment, a catholyte gradient composite cathode structure may have very low to no porosity.

In yet another aspect of the embodiment, active cathode materials may be coated with a thin protective layer to enhance chemical stability with the catholyte material.

In yet another aspect of the embodiment, a catholyte gradient composite cathode structure may be composed of various composite cathode formulations consisting of active cathode materials, with or without a protective coating, and one or more solid-state ionic conducting materials. In some instances, inactive materials, such as binding and electronically conducting additive materials may be incorporated.

In yet another aspect of the embodiment, a catholyte gradient composite cathode structure may be composed of three or more layers, wherein each layer may be formed using a specific composite cathode formulation, and the formulation has a specific catholyte mass percentage with respect to active cathode materials and inactive materials.

In yet another embodiment, a gradient solid-state battery layer may be composed of an anolyte gradient composite anode structure as the negative electrode.

In an aspect of the embodiment, an anolyte may be defined as a solid-state ionic conducting material within the composite anode structure.

In another aspect of the embodiment, an anolyte may be used in a solid-state lithium battery to facilitate ion conduction within the composite anode structure.

In yet another aspect of the embodiment, an anolyte gradient composite anode structure may have very low to no porosity.

In yet another aspect of the embodiment, active anode materials may be coated with a thin protective layer to enhance chemical stability with the anolyte material.

In yet another aspect of the embodiment, an anolyte gradient composite anode structure may be composed of various composite anode formulations consisting of active anode materials, with or without a protective coating, and one or more solid-state ionic conducting materials. In some instances, inactive materials, such as binding and electronically conducting additive materials may be incorporated.

In yet another aspect of the embodiment, an anolyte gradient composite anode structure may be composed of three or more layers, wherein each layer may be formed using a specific composite cathode formulation, and the formulation has a specific anolyte mass percentage with respect to active cathode materials and inactive materials.

In yet another embodiment, a gradient solid-state battery layer may be composed of a single solid-state electrolyte layer, separating the positive and negative electrodes.

In an aspect of the embodiment, a solid-state electrolyte layer may be composed of a solid-state ionic conductive material.

In yet another aspect of the embodiment, a solid-state electrolyte layer may be composed of a solid-state ionic conductive material and a polymer in what is referred to in the art as an ceramic-polymer composite solid-state electrolyte.

In yet another embodiment, gradient solid-state battery layers may be constructed using a solvent-based manufacturing method.

In an aspect of the embodiment, a solvent-based manufacturing method may be defined as liquid-based processing method, wherein composite cathode and composite anode formulation are in the form of a slurry (i.e., slurry formulations).

In another aspect of the embodiment, a solvent-based manufacturing method may enable composite electrode layers (i.e., composite cathode layers or composite anode layers) to be more uniformly mixed at their interfaces, forming a more systematic or uniform gradient at the microstructure with indistinguishable interfaces after drying, resulting in lower cell impedance, and higher power rates.

In yet another aspect of the embodiment, a solvent-based manufacturing method may include tape casting, wherein slurry formulations are cast using a doctor blade to form the composite electrode layers. Types of tape casting may include, for example, slurry casting, doctor blade casting, knife-over-edge coating, slot die coating, etc.

In yet another aspect of the embodiment, a solvent-based manufacturing method may include spraying, wherein slurry formulations are sprayed through a shower head or nozzle to form the composite electrode layers. Types of spraying may include, for example, spray pyrolysis, spray casting, etc.

In yet another aspect of the embodiment, a solvent-based manufacturing method may include ink jet printing, wherein slurry formulations are printed through a high-throughput 3D printing processing.

In yet another aspect of the embodiment, a solvent-based manufacturing method may include gravure printing, wherein slurry formulations are printed using a gravure cylinder. Other printing processes may include, for example, screen printing.

In yet another embodiment, a solvent-based manufacturing method may be used to form a catholyte gradient composite cathode structure followed by an anolyte gradient composite anode structure in a reverse gradient order.

In an aspect of the embodiment, a solvent-based manufacturing method may be used to form a first composite cathode layer onto a positive current collector, wherein the first layer may be formed using a composite cathode formulation with a catholyte mass percentage in the range of, for example, 70≤p≤0.01%, relative to the active and inactive material masses.

In another aspect of the embodiment, a solvent-based manufacturing method may be used to form a second composite cathode layer onto a first composite cathode layer, wherein the second layer may be formed using a composite cathode formulation with a catholyte mass percentage in the range of, for example, 75≤p≤0.05%, relative to the active and inactive material masses.

In another aspect of the embodiment, a solvent-based manufacturing method may be used to form a third composite cathode layer onto a second composite cathode layer, wherein the third layer may be formed using a composite cathode formulation with a catholyte mass percentage in the range of, for example, 80≤p≤0.1%, relative to the active and inactive material masses.

In yet another aspect of the embodiment, subsequent composite cathode layers may be formed using a composite cathode formulation with a higher amount of catholyte than that used to form the previous composite cathode layer, constructing the catholyte gradient composite cathode structure.

In yet another aspect of the embodiment, a solvent-based manufacturing method may be used to form a single solid-state electrolyte layer onto the catholyte gradient composite cathode structure.

In yet another aspect of the embodiment, a solvent-based manufacturing method may be used to form a first composite anode layer onto the solid-state electrolyte layer, wherein the first layer may be formed using a composite anode formulation with an anolyte mass percentage in the range of, for example, 80≤p≤0.1%, relative to the active and inactive material masses.

In yet another aspect of the embodiment, a solvent-based manufacturing method may be used to form a second composite anode layer onto a first composite anode layer, wherein the second layer may be formed using a composite anode formulation with an anolyte mass percentage in the range of, for example, 75≤p≤0.05%, relative to the active and inactive material masses.

In yet another aspect of the embodiment, a solvent-based manufacturing method may be used to form a third composite anode layer onto a second composite anode layer, wherein the third layer may be formed using a composite anode formulation with an anolyte mass percentage in the range of, for example, 70≤p≤0.01%, relative to the active and inactive material masses.

In yet another aspect of the embodiment, subsequent composite anode layers may be formed using a composite anode formulation with a lower amount of anolyte than that used to form the previous composite anode layer, constructing the anolyte gradient composite anode structure.

In yet another embodiment, a solvent-based manufacturing method may be used to form an anolyte gradient composite anode structure followed by a catholyte gradient composite cathode structure in a reverse gradient order.

In an aspect of the embodiment, a solvent-based manufacturing method may be used to form a first composite anode layer onto a negative current collector, wherein the first layer may be formed using a composite anode formulation with an anolyte mass percentage in the range of, for example, 70≤p≤0.01%, relative to the active and inactive material masses.

In another aspect of the embodiment, a solvent-based manufacturing method may be used to form a second composite anode layer onto a first composite anode layer, wherein the second layer may be formed using a composite anode formulation with an anolyte mass percentage in the range of, for example, 75≤p≤0.05%, relative to the active and inactive material masses.

In another aspect of the embodiment, a solvent-based manufacturing method may be used to form a third composite anode layer onto a second composite anode layer, wherein the third layer may be formed using a composite anode formulation with an anolyte mass percentage in the range of, for example, 80≤p≤0.1%, relative to the active and inactive material masses.

In yet another aspect of the embodiment, subsequent composite anode layers may be formed using a composite anode formulation with a higher amount of anolyte than that used to form the previous composite anode layer, constructing the anolyte gradient composite anode structure.

In yet another aspect of the embodiment, a solvent-based manufacturing method may be used to form a single solid-state electrolyte layer onto the anolyte gradient composite anode structure.

In yet another aspect of the embodiment, a solvent-based manufacturing method may be used to form a first composite cathode layer onto the solid-state electrolyte layer, wherein the first layer may be formed using a composite cathode formulation with a catholyte mass percentage in the range of, for example, 80≤p≤0.1%, relative to the active and inactive material masses.

In yet another aspect of the embodiment, a solvent-based manufacturing method may be used to form a second composite cathode layer onto a first composite cathode layer, wherein the second layer may be formed using a composite cathode formulation with a catholyte mass percentage in the range of, for example, 75≤p≤0.05%, relative to the active and inactive material masses.

In yet another aspect of the embodiment, a solvent-based manufacturing method may be used to form a third composite cathode layer onto a second composite cathode layer, wherein the third layer may be formed using a composite cathode formulation with a catholyte mass percentage in the range of, for example, 70≤p≤0.01%, relative to the active and inactive material masses.

In yet another aspect of the embodiment, subsequent composite cathode layers may be formed using a composite cathode formulation with a lower amount of catholyte than that used to form the previous composite cathode layer, constructing the catholyte gradient composite cathode structure.

In yet another embodiment, a gradient solid-state battery layer may be constructed using a high-throughput solvent-free manufacturing method.

In an aspect of the embodiment, a high-throughput solvent-free manufacturing method may be defined as an all-dry processing method without the use of any liquid-based solvents.

In yet another aspect of the embodiment, a high-throughput solvent-free manufacturing process may enable binder-free solid-state lithium battery architectures to be constructed, reducing cell impedance and enabling high power rates

In another aspect of the embodiment, a high-throughput solvent-free manufacturing process may include a cold temperature deposition process in what is referred to in the art as cold spray deposition. Types of cold spray deposition may include, for example, high-pressure and low-pressure cold spray depositions.

In yet another aspect of the embodiment, a high-throughput solvent-free manufacturing process may include a high-temperature deposition process in what is referred to in the art as thermal spray deposition. Types of thermal spray deposition include, for example, flame spray, plasma spray, wire arc spray, high-velocity oxygen fuel spraying, induction assisted, etc.

In yet another aspect of the embodiment, a high-throughput solvent-free manufacturing process may include a laser-assisted additive manufacturing processing, wherein dry composite cathode and composite anode formulations (i.e., composite cathode and composite anode layers) are heat treated with a laser to weld particles and layers together.

In yet another aspect of the embodiment, a high-throughput solvent-free manufacturing process may include powder aerosol deposition, electrostatic spray deposition, or 3D powder printing.

In yet another embodiment, a solvent-free manufacturing method may be used to form a catholyte gradient composite cathode structure followed by an anolyte gradient composite anode structure in a reverse gradient order.

In an aspect of the embodiment, a solvent-free manufacturing method may be used to form a first composite cathode layer onto a positive current collector, wherein the first layer may be formed using a composite cathode formulation with a catholyte mass percentage in the range of, for example, 70≤p≤0.01%, relative to the active and inactive material masses.

In another aspect of the embodiment, a solvent-free manufacturing method may be used to form a second composite cathode layer onto a first composite cathode layer, wherein the second layer may be formed using a composite cathode formulation with a catholyte mass percentage in the range of, for example, 75≤p≤0.05%, relative to the active and inactive material masses.

In another aspect of the embodiment, a solvent-free manufacturing method may be used to form a third composite cathode layer onto a second composite cathode layer, wherein the third layer may be formed using a composite cathode formulation with a catholyte mass percentage in the range of, for example, 80≤p≤0.1%, relative to the active and inactive material masses.

In yet another aspect of the embodiment, subsequent composite cathode layers may be formed using a composite cathode formulation with a higher amount of catholyte than that used to form the previous composite cathode layer, constructing the catholyte gradient composite cathode structure.

In yet another aspect of the embodiment, a solvent-free manufacturing method may be used to form a single solid-state electrolyte layer onto the catholyte gradient composite cathode structure.

In yet another aspect of the embodiment, a solvent-free manufacturing method may be used to form a first composite anode layer onto the solid-state electrolyte layer, wherein the first layer may be formed using a composite anode formulation with an anolyte mass percentage in the range of, for example, 80≤p≤0.1%, relative to the active and inactive material masses.

In yet another aspect of the embodiment, a solvent-free manufacturing method may be used to form a second composite anode layer onto a first composite anode layer, wherein the second layer may be formed using a composite anode formulation with an anolyte percentage mass in the range of, for example, 75≤p≤0.05%, relative to the active and inactive material masses.

In yet another aspect of the embodiment, a solvent-free manufacturing method may be used to form a third composite anode layer onto a second composite anode layer, wherein the third layer may be formed using a composite anode formulation with an anolyte mass percentage in the range of, for example, 70≤p≤0.01%, relative to the active and inactive material masses.

In yet another aspect of the embodiment, subsequent composite anode layers may be formed using a composite anode formulation with a lower amount of anolyte than that used to form the previous composite anode layer to form the anolyte gradient composite anode structure.

In yet another embodiment, a solvent-free manufacturing method may be used to form an anolyte gradient composite anode structure followed by a catholyte gradient composite cathode structure in a reverse gradient order.

In an aspect of the embodiment, a solvent-free manufacturing method may be used to form a first composite anode layer onto a negative current collector, wherein the first layer may be formed using a composite anode formulation with an anolyte mass percentage in the range of, for example, 70≤p≤0.01%, relative to the active and inactive material masses.

In another aspect of the embodiment, a solvent-free manufacturing method may be used to form a second composite anode layer onto a first composite anode layer, wherein the second layer may be formed using a composite anode formulation with an anolyte mass percentage in the range of, for example, 75≤p≤0.05%, relative to the active and inactive material masses.

In another aspect of the embodiment, a solvent-free manufacturing method may be used to form a third composite anode layer onto a second composite anode layer, wherein the third layer may be formed using a composite anode formulation with an anolyte mass percentage in the range of, for example, 80≤p≤0.1%, relative to the active and inactive material masses.

In yet another aspect of the embodiment, subsequent composite anode layers may be formed using a composite anode formulation with a higher amount of anolyte than that used to form the previous composite anode layer, constructing the anolyte gradient composite anode structure.

In yet another aspect of the embodiment, a solvent-free manufacturing method may be used to form a single solid-state electrolyte layer onto the anolyte gradient composite anode structure.

In yet another aspect of the embodiment, a solvent-free manufacturing method may be used to form a first composite cathode layer onto the solid-state electrolyte layer, wherein the first layer may be formed using a composite cathode formulation with a catholyte mass percentage in the range of, for example, 80≤p≤0.1%, relative to the active and inactive material masses.

In yet another aspect of the embodiment, a solvent-free manufacturing method may be used to form a second composite cathode layer onto a first composite cathode layer, wherein the second layer may be formed using a composite cathode formulation with a catholyte mass percentage in the range of, for example, 75≤p≤0.05%, relative to the active and inactive material masses.

In yet another aspect of the embodiment, a solvent-free manufacturing method may be used to form a third composite cathode layer onto a second composite cathode layer, wherein the third layer may be formed using a composite cathode formulation with a catholyte mass percentage in the range of, for example, 70≤p≤0.01%, relative to the active and inactive material masses.

In yet another aspect of the embodiment, subsequent composite cathode layers may be formed using a composite cathode formulation with a lower amount of catholyte than that used to form the previous composite cathode layer, constructing the catholyte gradient composite cathode structure.

The present disclosure relates to a catholyte gradient composite cathode structure.

A catholyte gradient composite cathode structure may be composed of an active cathode material, inactive materials, and a catholyte material.

The present description relates to active cathode material that make up a catholyte gradient composite cathode structure.

Active cathode materials may include intercalation material such as, for example, layered YMO₂, Y-rich layered Y₁₊ₓM₁₋ₓO₂, spinel YM₂O₄, olivine YMPO₄, silicate Y₂MSiO₄, borate YMBO₃, tavorite YMPO₄F (where M is Fe, Co, Ni, Mn, Cu, Cr, etc.), (where Y is Li, Na, K, Mg, Zn, Al, etc.), vanadium oxides, sulfur, lithium sulfide, iron sulfide, FeF₃, LiSe.

In the case of a lithium intercalation, active cathode materials may include, for example, lithium iron phosphate (LiFePO₄), lithium cobalt oxide (LiCoO₂), lithium manganese oxide (LiMn₂O₄), and lithium nickel oxide (LiNiO₂), lithium nickel cobalt manganese oxide (LiNiₓCo_{y}Mn_{z}O₂, 0.95≥x≥0.5, 0.3≥y≥0.025, 0.2≥z≥0.025), lithium nickel cobalt aluminum oxide (LiNiₓCo_{y}Al_{z}O₂, 0.95≥x≥0.5, 0.3≥y≥0.025, 0.2≥z≥0.025), lithium nickel manganese spinel (LiNi_{0.5}Mn_{1.5}O₄), etc.

Active cathode materials may be single crystal, polycrystalline, or amorphous.

Active cathode material may be coated with a protected layer to enhance chemical stability with a catholyte.

Protective coatings may include, for example, carbon, lithium niobate (LiNbO₃), lithium borate (Li₂B₄O₇), lithium zirconate (Li₂ZrO₃), lithium titanate (Li₄Ti₅O₁₂), aluminum oxide (Al₂O₃) etc.

The present description relates to inactive materials that may be included in a catholyte gradient composite cathode structure.

A catholyte gradient composite cathode structure may include an inactive binder such as, for example, polyvinylidene fluoride, polyacrylic acid, lotader, carboxymethyl cellulose, styrene-butadiene rubber, sodium alginate, etc.

A catholyte gradient composite cathode structure may include an inactive electronically conductive additive such as, for example, graphene, reduced graphene oxide, carbon nanotubes, carbon black, Super P, acetylene black, carbon nanofibers or a conductive polymer such as polyaniline, polypyrrole, poly(3,4-ethylenedioxythiophene (PEDOT), polyphenylene vinylene etc.

A catholyte gradient composite cathode structure may include an inactive metal binding materials that serve as an electronically conductive when using a solvent-free processing approach. Metal binding material may be in the form of, for example, wires, fibers, nanofibers, nanowires, nanorods, microfibers, etc.

Composite cathode formulations may contain a small amount of inactive lithium additives such as lithium nitrate or lithium bis(oxalato)borate to serve as of excess lithium source.

The present description relates to catholyte materials that make up a catholyte gradient composite cathode structure.

A catholyte includes or is formed from a solid-state ionic conductive material. A solid-state ionic conductive material can be described as a material that may have the following characteristics:

A solid-state ionic conductive material is a type of material that can selectively allow a specific charged element to pass through under a presence of an electric field or chemical potential, such as concentration differences.

While this solid-state ionic conductive material allows ions to migrate through, it may not allow electrons to pass easily.

The ions may carry 1, 2, 3, 4 or more positive charges. Examples of the charged ions include but not limited to H⁺, Li⁺, Na⁺, K⁺, Ag⁺, Mg²⁺, Zn²⁺, Fe³⁺, Al³⁺, etc.

The ionic conductivity of the corresponding ions is preferably to be >10⁻⁷ S/cm. It is preferably to have lower electrical conductivity (≤10⁻⁷ S/cm).

Examples of the solid-state ionic conductive material include but not limited to a garnet-like structure oxide material with the general formula:

Liₙ[A_{(3-a′-a″)}A′_{(a′)}A″_{(a″)}][B_{(2-b′-b″)}B′_{(b′)}B″_{(b″)}][C′_{(c′)}C″_{(c″)}]O₁₂,

a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;

b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;

c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤0.4; and

d. wherein n=7+a′+2·a″−b′−2·b″-3·c′−4·c″ and 4.5≤n≤7.5.

In another example, a solid-state ionic conductive material includes perovskite-type oxides such as (Li,La)TiO₃ or doped or replaced compounds.

In yet another example, a solid-state ionic conductive material includes NASICON-structured lithium membrane, such as LAGP (Li₁₋ₓAlₓGe₂₋ₓ(PO₄)₃), LATP (Li₁₊ₓAlₓTi₂₋ₓ(PO₄)₃) and these materials with other elements doped therein.

In yet another example, a solid-state ionic conductive material includes anti-perovskite structure materials and their derivatives, such as the composition of Li₃OCl, Li₃OBr, Li₃OI.

In yet another example, a solid-state ionic conductive material includes Li₃YH₆(H=F, Cl, Br, I) family of materials, Y can be replaced by other trivalent elements.

In yet another example, a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

In yet another example, a solid-state ionic conductive material includes argyrodites materials with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another example, a solid-state ionic conductive material includes argyrodites materials with the general formula: Li₁₈₋₂ₘ₋ₓM₂^{m+}Y₍₉₋ₓ₎₊ₙXₓ, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another example, a solid-state ionic conductive material includes alkali metal halides with the general formula AₐM_{b}^{m+}M′_{b′}^{m′+}X_{a+mb+m′b′}, where A=Li⁺, Na⁺, K⁺, or a combination thereof, X⁻=F⁻, Cl⁻, Br⁻, I⁻, or a combination thereof, M^{m+}=Ti²⁺, V²⁺, Cr²⁺, Mn²⁺, Fe²⁺, Co²⁺, Ni²⁺, Cu²⁺, Zn²⁺, Cd²⁺, Mg²⁺, Pb²⁺, Y³⁺, Sc³⁺, Lu³⁺, La³⁺, Al³⁺, Ga³⁺, In³⁺, Er³⁺, Ho³⁺, Ti³⁺, Cr³⁺, V³⁺, Hf⁴⁺, Zr⁴⁺, V⁴⁺Ti⁴⁺, Mo⁴⁺, W⁴⁺, V⁵⁺, Nb⁵⁺, Ta⁵⁺, Cr⁶⁺, Mo⁶⁺, W⁶⁺, etc., and M′^{m+} may be metal with the same valance state as M^{m+} when b′ is greater than 0, or an aliovalent substitution when b′ is greater than 0.

An catholyte may include a mixture of two or more solid-state ionic conductive materials.

In some instances, a catholyte may be coated onto the active material prior to solvent-based or solvent-free processing, wherein the catholyte-active cathode materials form a core-shell structure. In such an instance, the active cathode materials may be coated with a protective layer.

The present disclosure relates to an anolyte gradient composite anode structure.

An anolyte gradient composite anode structure may be composed of an active cathode material, inactive materials, and a catholyte material.

The present description relates to active anode material that make up an anolyte gradient composite anode structure.

An active anode material may interact with ions through various mechanisms including, but not limited to, intercalation, alloying, plating, or conversion.

An active anode material may include, for example, lithium powder, titanium oxide, silicon, tin oxide, germanium, antimony, silicon oxide, iron oxide, cobalt oxide, ruthenium oxide, molybdenum oxide, molybdenum sulfide, chromium oxide, nickel oxide, manganese oxide, carbon-based materials (hard carbons, soft carbons, graphene, graphite's, carbon nanofibers, carbon nanotubes, etc.), or a combination thereof.

In the case of lithium powder, alloying materials may be introduced into the composite anode structure which include, for example, tin, zinc, indium, magnesium, etc.

Active materials may be coated with a protective layer serving as a solid electrolyte interface to enhance chemical stability with an anolyte.

Protective coatings may include, for example, carbon, lithium niobate (LiNbO₃), lithium borate (Li₂B₄O₇), lithium zirconate (Li₂ZrO₃), lithium titanate (Li₄Ti₅O₁₂), aluminum oxide (Al₂O₃) etc.

The present description relates to inactive materials that may be included in an anolyte gradient composite anode structure.

An anolyte gradient composite anode structure may include an inactive binder such as, for example, polyvinylidene fluoride, polyacrylic acid, lotader, carboxymethyl cellulose, styrene-butadiene rubber, sodium alginate, etc.

An anolyte gradient composite anode structure may include an inactive electronically conductive additive such as, for example, graphene, reduced graphene oxide, carbon nanotubes, carbon black, Super P, acetylene black, carbon nanofibers or a conductive polymer such as polyaniline, polypyrrole, poly(3,4-ethylenedioxythiophene (PEDOT), polyphenylene vinylene etc.

An anolyte gradient composite anode structure may include an inactive metal binding materials that serves as an electronically conductive when using a solvent-free processing approach. Metal binding material may be in the form of, for example, wires, fibers, nanofibers, nanowires, nanorods, microfibers, etc.

Composite anode formulations may contain a small amount of inactive lithium additives such as lithium nitrate or lithium bis(oxalato)borate to serve as of excess lithium source.

The present description relates to anolyte materials that make up an anolyte gradient composite anode structure.

An anolyte includes or is formed from a solid-state ionic conductive material. A solid-state ionic conductive material can be described as a material that may have the following characteristics:

A solid-state ionic conductive material is a type of material that can selectively allow a specific charged element to pass through under a presence of an electric field or chemical potential, such as concentration differences.

While this solid-state ionic conductive material allows ions to migrate through, it may not allow electrons to pass easily.

The ions may carry 1, 2, 3, 4 or more positive charges. Examples of the charged ions include but not limited to H⁺, Li⁺, Na⁺, K⁺, Ag⁺, Mg²⁺, Zn²⁺, Fe³⁺, Al³⁺, etc.

The ionic conductivity of the corresponding ions is preferably to be >10⁻⁷ S/cm. It is preferably to have lower electrical conductivity (≤10⁻⁷ S/cm).

Examples of the solid-state ionic conductive material include but not limited to a garnet-like structure oxide material with the general formula:

Liₙ[A_{(3-a′-a″)}A′_{(a′)}A″_{(a″)}][B_{(2-b′-b″)}B′_{(b′)}B″_{(b″)}][C′_{(c′)}C″_{(c″)}]O₁₂,

a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;

b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;

c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤0.4; and

d. wherein n=7+a′+2·a″−b′−2·b″−3·c′−4·c″ and 4.5≤n≤7.5.

In another example, a solid-state ionic conductive material includes perovskite-type oxides such as (Li,La)TiO₃ or doped or replaced compounds.

In yet another example, a solid-state ionic conductive material includes NASICON-structured lithium membrane, such as LAGP (Li₁₋ₓAlₓGe₂₋ₓ(PO₄)₃), LATP (Li₁₊ₓAlₓTi₂₋ₓ(PO₄)₃) and these materials with other elements doped therein.

In yet another example, a solid-state ionic conductive material includes anti-perovskite structure materials and their derivatives, such as the composition of Li₃OCl, Li₃OBr, Li₃OI.

In yet another example, a solid-state ionic conductive material includes Li₃YH₆(H=F, Cl, Br, I) family of materials, Y can be replaced by other trivalent elements.

In yet another example, a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

In yet another example, a solid-state ionic conductive material includes argyrodites materials with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof. Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another example, a solid-state ionic conductive material includes argyrodites materials with the general formula: Li₁₈₋₂ₘ₋ₓM₂^{m+}Y₍₉₋ₓ₎₊ₙXₓ, wherein M^{m+}=B³⁺, Ga³⁺, Sb³⁺, Si⁴⁺, Ge⁴⁺, P⁵⁺, As⁵⁺, or a combination thereof. Y²⁻=O²⁻, S²⁻, Se²⁻, Te²⁻, or a combination thereof. X⁻=F⁻, Cl⁻, Br⁻, I⁻, or a combination thereof; and x is in the range of 0≤x≤2.

In yet another example, a solid-state ionic conductive material includes alkali metal halides with the general formula AₐM_{b}^{m+}M′_{b′}^{m′+}X_{a+mb+m′b′}, where A=Li⁺, Na⁺, K⁺, or a combination thereof, X⁻=F⁻, Cl⁻, Br⁻, I⁻, or a combination thereof, M^{m+}=Ti²⁺, V²⁺, Cr²⁺, Mn²⁺, Fe²⁺, Co²⁺, Ni²⁺, Cu²⁺, Zn²⁺, Cd²⁺, Mg²⁺, Pb²⁺, Y³⁺, Sc³⁺, Lu³⁺, La³⁺, Al³⁺, Ga³⁺, In³⁺, Er³⁺, Ho³⁺, Ti³⁺, Cr³⁺, V³⁺, Hf⁴⁺, Zr⁴⁺, V⁴⁺, Ti⁴⁺, Mo⁴⁺, W⁴⁺, V⁵⁺, Nb⁵⁺, Ta⁵⁺, Cr⁶⁺, Mo⁶⁺, W⁶⁺, etc., and M′^{m+} may be metal with the same valance state as M^{m+} when b′ is greater than 0, or an aliovalent substitution when b′ is greater than 0.

An anolyte may include a mixture of two or more solid-state ionic conductive materials.

In some instances, an anolyte may be coated onto the active material prior to solvent-based or solvent-free processing, wherein the anolyte-active anode materials form a core-shell structure. In such an instance, the active anode materials may be coated with a protective layer.

The present disclosure relates to a solid-state electrolyte layer.

A solid-state electrolyte layer includes or is formed from a solid-state ionic conductive material. A solid-state ionic conductive material can be described as a material that may have the following characteristics:

A solid-state ionic conductive material is a type of material that can selectively allow a specific charged element to pass through under a presence of an electric field or chemical potential, such as concentration differences.

While this solid-state ionic conductive material allows ions to migrate through, it may not allow electrons to pass easily.

The ions may carry 1, 2, 3, 4 or more positive charges. Examples of the charged ions include but not limited to H⁺, Li⁺, Na⁺, K⁺, Ag⁺, Mg²⁺, Zn²⁺, Fe³⁺, Al³⁺, etc.

The ionic conductivity of the corresponding ions is preferably to be >10⁻⁷ S/cm. It is preferably to have lower electrical conductivity (≤10⁻⁷ S/cm).

Examples of the solid-state ionic conductive material include but not limited to a garnet-like structure oxide material with the general formula:

Liₙ[A_{(3-a′-a″)}A′_{(a′)}A″_{(a″)}][B_{(2-b′-b″)}B′_{(b′)}B″_{(b″)}][C′_{(c′)}C″_{(c″)}]O₁₂,

a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;

b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;

c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤0.4; and

d. wherein n=7+a′+2·a″−b′−2·b″−3·c′−4·c″ and 4.5≤n≤7.5.

In another example, a solid-state ionic conductive material includes perovskite-type oxides such as (Li,La)TiO₃ or doped or replaced compounds.

In yet another example, a solid-state ionic conductive material includes NASICON-structured lithium membrane, such as LAGP (Li₁₋ₓAlₓGe₂₋ₓ(PO₄)₃), LATP (Li₁₊ₓAlₓTi₂₋ₓ(PO₄)₃) and these materials with other elements doped therein.

In yet another example, a solid-state ionic conductive material includes anti-perovskite structure materials and their derivatives, such as the composition of Li₃OCl, Li₃OBr, Li₃OI.

In yet another example, a solid-state ionic conductive material includes Li₃YH₆(H=F, Cl, Br, I) family of materials, Y can be replaced by other trivalent elements.

In yet another example, a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

In yet another example, a solid-state ionic conductive material includes argyrodites materials with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another example, a solid-state ionic conductive material includes argyrodites materials with the general formula: Li₁₈₋₂ₘ₋ₓM₂^{m+}Y₍₉₋ₓ₎₊ₙXₓ, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another example, a solid-state ionic conductive material includes alkali metal halides with the general formula AₐM_{b}^{m+}M′_{b′}^{m′+}X_{a+mb+m′b′}, where A=Li⁺, Na⁺, K⁺, or a combination thereof, X⁻=F⁻, Cl⁻, Br⁻, I⁻, or a combination thereof, M^{m+}=Ti²⁺, V²⁺, Cr²⁺, Mn²⁺, Fe²⁺, Co²⁺, Ni²⁺, Cu²⁺, Zn²⁺, Cd²⁺, Mg²⁺, Pb²⁺, Y³⁺, Sc³⁺, Lu³⁺, La³⁺, Al³⁺, Ga³⁺, In³⁺, Er³⁺, Ho³⁺, Ti³⁺, Cr³⁺, V³⁺, Hf⁴⁺, Zr⁴⁺, V⁴⁺, Ti⁴⁺, Mo⁴⁺, W⁴⁺, V⁵⁺, Nb⁵⁺, Ta⁵⁺, Cr⁶⁺, Mo⁶⁺, W⁶⁺, etc., and M′^{m+} may be metal with the same valance state as M^{m+} when b′ is greater than 0, or an aliovalent substitution when b′ is greater than 0.

A solid-state electrolyte layer may be a mixture of two or more solid-state ionic conductive materials.

A solid-state ionic conductive material in a solid-state electrolyte layer may be the same solid-state ionic conductive material in a catholyte gradient composite cathode structure.

A solid-state ionic conductive material in a solid-state electrolyte layer may be the same solid-state ionic conductive material in an anolyte gradient composite anode structure.

In some instances, a solid-state electrolyte layer may be a ceramic-polymer composite, composed of a solid-state ionic conductive material and a binding polymer.

A binding polymer may include, for example, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(E-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(E-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK).

A ceramic-polymer composition may contain an ionic conducting salt. An example of an ionic conducting salt may include, for example, lithium bis(trifluoromethanesulfonyl)imide (LiTFSI) and lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), LiNO₃, sodium bis(trifluoromethanesulfonyl)imide (NaTFSI) and sodium bis(fluorosulfonyl)imide (NaFSI), sodium bis(oxalato)borate (NaBOB) Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, NaNO₃, magnesium bis(trifluoromethanesulfonyl)imide (Mg(TFSI)₂) and magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, Mg(CH₃COOH)₂, potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KClO₄, KAsF₆, KSO₃CF₃, KSO₃CH₃, KBF₄, KB(Ph)₄, KPF₆, KC(SO₂CF₃)₃, KN(SO₂CF₃)₂), KNO₃, Al(NO₃)₂, AlCl₃, Al₂(SO₄)₃, AlBr₃, AlI₃, AlN, AlSCN, Al(ClO₄)₃.

The present disclosure relates to a gradient solid-state battery layer.

A gradient solid-state battery layer may be composed of a catholyte gradient composite cathode structure and an anolyte gradient composite anode structure, separated by a single solid-state electrolyte layer.

A catholyte gradient composite cathode structure may be composed of three or more composite cathode layers, wherein each layer may be formed using a composite cathode formulation with a specific catholyte mass percentage with respect to active cathode and inactive materials.

An anolyte gradient composite anode structure may be composed of three or more composite anode layers, wherein each layer may be formed using a composite anode formulation with a specific anolyte mass percentage with respect to active anode and inactive materials.

In an example, a gradient solid-state battery layer may be formed onto a positive current collector, wherein a catholyte gradient composite cathode structure may be formed followed by a single solid-state electrolyte layer and an anolyte gradient composite cathode structure in a reverse gradient order.

In an aspect of the example, a first composite cathode layer may be formed onto a positive current collector, wherein the first layer may be formed using a composite cathode formulation with a catholyte mass percentage in the range of 70≤p≤0.01%, with a preferred range of 30≤p≤0.1%, relative to the active and inactive material masses.

In another aspect of the example, a second composite cathode layer may be formed onto a first composite cathode layer, wherein the second layer may be formed using a composite cathode formulation with a catholyte mass percentage in the range of 75≤p≤0.05%, with a preferred range of 35≤p≤0.5%, relative to the active and inactive material masses.

In another aspect of the example, a third composite cathode layer may be formed onto a second composite cathode layer, wherein the third layer may be formed using a composite cathode formulation with a catholyte mass percentage in the range of 80≤p≤0.1%, with a preferred range of 40≤p≤1.0%, relative to the active and inactive material masses.

In yet another aspect of the example, subsequent composite cathode layers may be formed using a composite cathode formulation with a higher amount of catholyte than that used to form the previous composite cathode layer, constructing the catholyte gradient composite cathode structure.

In yet another aspect of the example, a single solid-state electrolyte layer may be formed onto the catholyte gradient composite cathode structure.

In yet another aspect of the example, a first composite anode layer may be formed onto the solid-state electrolyte layer, wherein the first layer may be formed using a composite anode formulation with an anolyte mass percentage in the range of 80≤p≤0.1%, with a preferred range of 40≤p≤1.0%, relative to the active and inactive material masses.

In yet another aspect of the example, a second composite anode layer may be formed onto a first composite anode layer, wherein the second layer may be formed using a composite anode formulation with an anolyte percentage mass in the range of 75≤p≤0.05%, with a preferred range of 35≤p≤0.5%, relative to the active and inactive material masses.

In yet another aspect of the example, a third composite anode layer may be formed onto a second composite anode layer, wherein the third layer may be formed using a composite anode formulation with an anolyte mass percentage in the range of 70≤p≤0.01%, with a preferred range of 30≤p≤0.1%, relative to the active and inactive material masses.

In yet another aspect of the embodiment, subsequent composite anode layers may be formed using a composite anode formulation with a lower amount of anolyte than that used to form the previous composite anode layer to form the anolyte gradient composite anode structure.

In another example, a gradient solid-state battery layer may be formed onto a negative current collector, wherein an anolyte gradient composite anode structure may be formed followed by a single solid-state electrolyte layer and a catholyte gradient composite cathode structure in a reverse gradient order.

In an aspect of the example, a first composite anode layer may be formed onto a negative current collector, wherein the first layer may be formed using a composite anode formulation with an anolyte mass percentage in the range of 70≤p≤0.01%, with a preferred range of 30≤p≤0.1%, relative to the active and inactive material masses.

In another aspect of the example, a second composite anode layer may be formed onto a first composite anode layer, wherein the second layer may be formed using a composite anode formulation with an anolyte mass percentage in the range of 75≤p≤0.05%, with a preferred range of 35≤p≤0.5%, relative to the active and inactive material masses.

In yet another aspect of the example, a third composite anode layer may be formed onto a second composite anode layer, wherein the third layer may be formed using a composite anode formulation with an anolyte mass percentage in the range of 80≤p≤0.1%, with a preferred range of 40≤p≤1.0%, relative to the active and inactive material masses.

In yet another aspect of the example, subsequent composite anode layers may be formed using a composite anode formulation with a higher amount of anolyte than that used to form the previous composite anode layer, constructing the anolyte gradient composite anode structure.

In yet another aspect of the example, a single solid-state electrolyte layer may be formed onto the anolyte gradient composite anode structure.

In yet another aspect of the example, a first composite cathode layer may be formed onto the solid-state electrolyte layer, wherein the first layer may be formed using a composite cathode formulation with a catholyte mass percentage in the range of 80≤p≤0.1%, with a preferred range of 40≤p≤1.0%, relative to the active and inactive material masses.

In yet another aspect of the example, a second composite cathode layer may be formed onto a first composite cathode layer, wherein the second layer may be formed using a composite cathode formulation with a catholyte percentage mass in the range of 75≤p≤0.05%, with a preferred range of 35≤p≤0.5%, relative to the active and inactive material masses.

In yet another aspect of the example, a third composite cathode layer may be formed onto a second composite cathode layer, wherein the third layer may be formed using a composite cathode formulation with a catholyte mass percentage in the range of 70≤p≤0.01%, with a preferred range of 30≤p≤0.1%, relative to the active and inactive material masses.

In yet another aspect of the embodiment, subsequent composite cathode layers may be formed using a composite cathode formulation with a lower amount of catholyte than that used to form the previous composite cathode layer to form the catholyte gradient composite cathode structure.

The present disclosure relates to a solvent-based manufacturing method for gradient solid-state battery layers.

A solvent-based manufacturing method may be defined as a processing approach that uses a liquid-based media to form a slurry, wherein the slurry may be used to form the composite cathode, solid-state electrolyte, and composite anode layers that make up a gradient solid-state battery layer.

A solvent-based manufacturing method may be used to form a catholyte gradient composite cathode structure, wherein the composite cathode formulation may be in a slurry form. The composite cathode slurry may be composed of a binding polymer, wherein the solvent may be chemically stable with the active and catholyte materials but dissolves the binding polymer.

A solvent-based manufacturing method may enable composite cathode layers to be more uniformly mixed at their interfaces, forming a more systematic or uniform catholyte gradient composite cathode at the microstructure with indistinguishable interfaces after drying, resulting in lower cell impedance, and higher power rates.

A solvent-based manufacturing method may be used to form an anolyte gradient composite anode structure, wherein the composite anode formulation may be in a slurry form. The composite anode slurry may be composed of a binding polymer, wherein the solvent may be chemically stable with the active anode and anolyte materials but dissolves the binding polymer.

A solvent-based manufacturing method may enable composite anodes layers to be more uniformly mixed at their interfaces, forming a more systematic or uniform anolyte gradient composite cathode at the microstructure with indistinguishable interfaces after drying, resulting in lower cell impedance, and higher power rates.

A solvent-based manufacturing method may be used to form a solid-state electrolyte layer, wherein the solid-state electrolyte formulation may be in a slurry form. The solid-state electrolyte slurry may be composed of a binding polymer, wherein the solvent may be chemically stable with the solid-state ionic conductive materials but dissolves the binding polymer.

A solid-state electrolyte layer may be formed onto a catholyte gradient composite cathode structure using a solvent-based manufacturing method. A solvent-based manufacturing method may enable a more uniform interface at the composite cathode interface, forming a more systematic or uniform microstructure with indistinguishable interfaces after drying, resulting in lower cell impedance, and higher power rates.

A solid-state electrolyte layer may be formed onto an anolyte gradient composite anode structure using a solvent-based manufacturing method. A solvent-based manufacturing method may enable a more uniform interface at the composite anode interface, forming a more systematic or uniform microstructure with indistinguishable interfaces after drying, resulting in lower cell impedance, and higher power rates.

A solvent-based manufacturing method may be done in a dry or inert environment.

A solvent-based manufacturing method may be done in a roll-to-roll process.

A solvent-based manufacturing method may be done manually or thorough an automated process controlled via hard wire or WIFI. An automated process may use robotic arms throughout a roll-to-roll process.

A solvent-based manufacturing method may have one or more drying steps to remove the solvent from the catholyte gradient composite cathode structure. Drying may be done using heat, vacuum, or combination thereof.

A solvent-based manufacturing method may have one or more hot calendering steps to densify the catholyte gradient composite cathode structure.

A solvent-based manufacturing method may have one or more hot calendering steps to densify the catholyte gradient composite cathode structure.

A solvent-based manufacturing method may have one or more drying steps to remove the solvent from the solid-state electrolyte layer. Drying may be done using heat, vacuum, or combination thereof.

A solvent-based manufacturing method may have one or more hot calendering steps to densify the solid-state electrolyte layer.

A solvent-based manufacturing method may have one or more drying steps to remove the solvent from the anolyte gradient composite anode structure. Drying may be done using heat, vacuum, or combination thereof.

A solvent-based manufacturing method may have one or more hot calendering steps to densify the anolyte gradient composite anode structure.

A solvent-based manufacturing method may have one or more hot calendering steps to densify the gradient solid-state battery layer. An example of a solvent-based manufacturing method may include tape casting, wherein slurry formulations are casted using a doctor blade to form a gradient solid-state battery layer. Types of tape casting may include, for example, slurry casting, doctor blade casting, knife-over-edge coating, slot die coating, etc.

In an aspect of the example, a tape casting approach may be used to manufacture a catholyte gradient composite cathode structure onto a positive current collector, wherein each composite cathode layer may be formed one layer at a time using one or more doctor blades. Composite cathode layers may have a thickness in the range of 0.1≤t≤1000 μm, with a preferred range of 1≤t≤100 μm.

In another aspect of the example, a tape casting approach may be used to manufacture a solid-state electrolyte layer onto a catholyte gradient composite cathode structure, wherein one or more doctor blades are used to form the ionic conducting layer. Solid-state electrolyte layer may have a thickness in the range of 0.1≤t≤500 μm, with a preferred range of 1≤t≤50 μm.

In yet another aspect of the example, a tape casting approach may be used to manufacture an anolyte gradient composite anode structure onto a solid-state electrolyte layer, wherein each composite anode layer may be formed one layer at a time using one or more doctor blades. Composite anode layers may have a thickness in the range of 0.1≤t≤1000 μm, with a preferred range of 1≤t≤100 μm.

In yet another aspect of the example, a tape casting approach may be used to manufacture an anolyte gradient composite anode structure onto a negative current collector, wherein each composite anode layer may be formed one layer at a time using one or more doctor blades. Composite cathode layers may have a thickness in the range of 0.1≤t≤1000 μm, with a preferred range of 1≤t≤100 μm.

In yet another aspect of the example, a tape casting approach may be used to manufacture a solid-state electrolyte layer onto an anolyte gradient composite anode structure, wherein one or more doctor blades are used to form the ionic conducting layer. The solid-state electrolyte layer may have a thickness in the range of 0.1≤t≤500 μm, with a preferred range of 1≤t≤50 μm.

In yet another aspect of the example, a tape casting approach may be used to manufacture a catholyte gradient composite cathode structure onto a solid-state electrolyte layer, wherein each composite cathode layer may be formed one layer at a time using one or more doctor blades. Composite cathode layers may have a thickness in the range of 0.1≤t≤1000 μm, with a preferred range of 1≤t≤100 μm.

Another example of a solvent-based manufacturing method may include spraying, wherein slurry formulations are sprayed through a shower head or nozzle to form a gradient solid-state battery layer. Types of spraying may include, for example, spray pyrolysis, spray casting, etc.

In an aspect of the example, a spraying approach may be used to manufacture a catholyte gradient composite cathode structure onto a positive current collector, wherein each composite cathode layer may be formed one layer at a time using one or more shower heads or nozzles. Composite cathode layers may have a thickness in the range of 0.1≤t≤1000 μm, with a preferred range of 1≤t≤100 μm.

In another aspect of the example, a spraying approach may be used to manufacture a solid-state electrolyte layer onto a catholyte gradient composite cathode structure, wherein one or more shower heads or nozzles are used to form the ionic conducting layer. The solid-state electrolyte layer may have a thickness in the range of 0.1≤t≤500 μm, with a preferred range of 1≤t≤50 μm.

In yet another aspect of the example, a spraying approach may be used to manufacture an anolyte gradient composite anode structure onto a solid-state electrolyte layer, wherein each composite anode layer may be formed one layer at a time using one or more shower heads or nozzles. Composite anode layers may have a thickness in the range of 0.1≤t≤1000 μm, with a preferred range of 1≤t≤100 μm.

In yet another aspect of the example, a spraying approach may be used to manufacture an anolyte gradient composite anode structure onto a negative current collector, wherein each composite anode layer may be formed one layer at a time using one or more shower heads or nozzles. Composite anodes layers may have a thickness in the range of 0.1≤t≤1000 μm, with a preferred range of 1≤t≤100 μm.

In yet another aspect of the example, a spraying approach may be used to manufacture a solid-state electrolyte layer onto an anolyte gradient composite anode structure, wherein one or more shower heads or nozzles are used to form the ionic conducting layer. The solid-state electrolyte layer may have a thickness in the range of 0.1≤t≤500 μm, with a preferred range of 1≤t≤50 μm.

In yet another aspect of the example, a spraying approach may be used to manufacture a catholyte gradient composite cathode structure onto a solid-state electrolyte layer, wherein each composite cathode layer may be formed one layer at a time using one or more shower heads or nozzles. Composite cathode layers may have a thickness in the range of 0.1≤t≤1000 μm, with a preferred range of 1≤t≤100 μm.

In yet another aspect of the example, the one or more shower heads or nozzles may remain stationary or move in a controlled raster like fashion to form the gradient solid-state battery layer.

Yet another example of a solvent-based manufacturing method may include ink jet printing to form a gradient solid-state battery layer, wherein slurry formulation are printed through a high-throughput 3D printing processing.

In an aspect of the example, an ink jet printing approach may be used to manufacture a catholyte gradient composite cathode structure onto a positive current collector, wherein each composite cathode layer may be formed one layer at a time using one or more ink jet printing heads. Composite cathode layers may have a thickness in the range of 0.1≤t≤1000 μm, with a preferred range of 1≤t≤100 μm.

In another aspect of the example, an ink jet printing approach may be used to manufacture a solid-state electrolyte layer onto a catholyte gradient composite cathode structure, wherein one or more ink jet printing heads are used to form the ionic conducting layer. The solid-state electrolyte layer may have a thickness in the range of 0.1≤t≤500 μm, with a preferred range of 1≤t≤50 μm.

In yet another aspect of the example, an ink jet printing approach may be used to manufacture an anolyte gradient composite anode structure onto a solid-state electrolyte layer, wherein each composite anode layer may be formed one layer at a time using one or more ink jet printing heads. Composite anode layers may have a thickness in the range of 0.1≤t≤1000 with a preferred range of 1≤t≤100 μm.

In yet another aspect of the example, an ink jet printing approach may be used to manufacture an anolyte gradient composite anode structure onto a negative current collector, wherein each composite anode layer may be formed one layer at a time using one or more ink jet printing heads. Composite anode layers may have a thickness in the range of 0.1≤t≤1000 with a preferred range of 1≤t≤100 μm.

In yet another aspect of the example, an ink jet printing approach may be used to manufacture a solid-state electrolyte layer onto an anolyte gradient composite anode structure, wherein one or more ink jet printing heads are used to form the ionic conducting layer. The solid-state electrolyte layer may have a thickness in the range of 0.1≤t≤500 μm, with a preferred range of 1≤t≤50 μm.

In yet another aspect of the example, an ink jet printing approach may be used to manufacture a catholyte gradient composite cathode structure onto a solid-state electrolyte layer, wherein each composite cathode layer may be formed one layer at a time using one or more ink jet printing heads. Composite cathode layers may have a thickness in the range of 0.1≤t≤1000 μm, with a preferred range of 1≤t≤100 μm.

In yet another aspect of the example, the one or more ink jet printing heads may remain stationary or move in a controlled raster like fashion to form the gradient solid-state battery layer

Yet another example of a solvent-based manufacturing method may include gravure printing, wherein slurry formulations are printing using a gravure cylinder to form a gradient solid-state battery layer. Other printing processes may include, for example screen printing.

In an aspect of the example, a gravure printing approach may be used to manufacture a catholyte gradient composite cathode structure onto a positive current collector, wherein each composite cathode layer may be formed one layer at a time using one or more gravure cylinders. Composite cathode layers may have a thickness in the range of 0.1≤t≤1000 μm, with a preferred range of 1≤t≤100 μm.

In another aspect of the example, a gravure printing approach may be used to manufacture a solid-state electrolyte layer onto a catholyte gradient composite cathode structure, wherein one or more gravure cylinders are used to form the ionic conducting layer. The solid-state electrolyte layer may have a thickness in the range of 0.1≤t≤500 μm, with a preferred range of 1≤t≤50 μm.

In yet another aspect of the example, a gravure printing approach may be used to manufacture an anolyte gradient composite anode structure onto a solid-state electrolyte layer, wherein each composite anode layer may be formed one layer at a time using one or more gravure cylinders. Composite anode layers may have a thickness in the range of 0.1≤t≤1000 μm, with a preferred range of 1≤t≤100 μm.

In yet another aspect of the example, a gravure printing approach may be used to manufacture an anolyte gradient composite anode structure onto a negative current collector, wherein each composite anode layer may be formed one layer at a time using one or more gravure cylinders. Composite anode layers may have a thickness in the range of 0.1≤t≤1000 μm, with a preferred range of 1≤t≤100 μm.

In yet another aspect of the example, a gravure printing approach may be used to manufacture a solid-state electrolyte layer onto an anolyte gradient composite anode structure, wherein one or more gravure cylinders are used to form the ionic conducting layer. Solid-state electrolyte layers may have a thickness in the range of 0.1≤t≤500 μm, with a preferred range of 1≤t≤50 μm.

In yet another aspect of the example, a gravure printing approach may be used to manufacture a catholyte gradient composite cathode structure onto a solid-state electrolyte layer, wherein each composite cathode layer may be formed one layer at a time using one or more gravure cylinders. Composite cathode layers may have a thickness in the range of 0.1≤t≤1000 μm, with a preferred range of 1≤t≤100 μm.

In an example, a catholyte gradient composite cathode structure may be formed onto a positive current collector followed by a solid-state electrolyte layer and an anolyte gradient composite anode structure using an aforementioned solvent-based manufacturing approach.

In an aspect of the example, a first composite cathode layer may be formed onto a positive current collector using a first composite cathode slurry formulation with a low catholyte mass percentage.

In another aspect of the example, a second composite cathode layer may be formed onto a first composite cathode layer using a second composite cathode slurry formulation with a higher catholyte mass percentage than the first composite cathode slurry formulation.

In yet another aspect of the example, a third composite cathode layer may be formed onto a second composite cathode layer using a third composite cathode slurry formulation with a higher catholyte mass percentage than the second composite cathode slurry formulation, forming the catholyte gradient composite cathode structure.

In yet another aspect of the example, additional composite cathode layers may be formed, wherein the composite cathode slurry formulation has a higher catholyte mass percentage than that used to form the previous layer.

In yet another aspect of the example, a catholyte gradient composite cathode structure may be partially or fully dried to remove the solvent. Alternatively, each composite cathode layer may be partially or fully dried prior to the formation of the next layer, or a combination thereof. In yet another alternative, the catholyte gradient composite cathode structure may not be dried.

In yet another aspect of the example, a catholyte gradient composite cathode structure may be hot calendered to partially or fully densify the gradient structure. Alternatively, each composite cathode layer may be hot calendered to partially or fully densify the layer prior to the formation of the next layer, or a combination thereof. In yet another alternative, the catholyte gradient composite may not be hot calendered.

In yet another aspect of the example, a solid-state electrolyte layer may be formed onto the catholyte gradient composite cathode structure.

In yet another aspect of the example, a solid-state electrolyte layer may be partially of fully dried to remove the solvent. Alternatively, a solid-state electrolyte layer may not be dried.

In yet another aspect of the example, a solid-state electrolyte layer may be hot calendered to partially or fully densify the ionic conducting layer. Alternatively, the solid-state electrolyte layer may not be hot calendered.

In yet another aspect of the example, a first composite anode layer may be formed onto the solid-state electrolyte layer using a composite anode slurry formulation with a high anolyte mass percentage.

In yet another aspect of the example, a second composite anode layer may be formed onto the first composite anode layer using a composite anode slurry formulation with a lower anolyte mass percentage than the first composite anode slurry formulation.

In yet another aspect of the example, a third composite anode layer may be formed onto the second composite anode layer using a composite anode slurry formulation with a lower anolyte mass percentage than the second composite cathode slurry formulation.

In yet another aspect of the example, additional composite anodes layers may be formed, wherein the composite anode slurry formation has a lower anolyte mass percentage than that used to form the previous layer.

In yet another aspect of the example, an anolyte gradient composite anode structure may be partially or fully dried to remove the solvent. Alternatively, each composite anode layer may be partially or fully dried prior to the formation of the next layer, or a combination thereof. In yet another alternative, the anolyte gradient composite anode structure may not be dried.

In yet another aspect of the example, an anolyte gradient composite anode structure may be hot calendered to partially or fully densify the gradient structure. Alternatively, each composite anode layer may be hot calendered to partially or fully densify the layer prior to the formation of the next layer, or a combination thereof. In yet another alternative, the anolyte gradient composite may not be hot calendered.

In yet another aspect of the example, a gradient solid-state battery layer may be dried once after its formation and then hot calendered.

In yet another aspect of the example, a negative current collector may be laminated onto the third or last composite anode layer.

In another example, an anolyte gradient composite anode structure may be formed onto a negative current collector followed by a solid-state electrolyte layer and a catholyte gradient composite cathode structure using an aforementioned solvent-based manufacturing approach.

In an aspect of the example, a first composite anode layer may be formed onto a negative current collector using a first composite anode slurry formulation with a low anolyte mass percentage.

In another aspect of the example, a second composite anode layer may be formed onto a first composite anode layer using a second composite anode slurry formulation with a higher anolyte mass percentage than the first composite anode slurry formulation.

In yet another aspect of the example, a third composite anode layer may be formed onto a second composite anode layer using a third composite anode slurry formulation with a higher anolyte mass percentage than the second composite anode slurry formulation, forming an anolyte gradient composite anode structure.

In yet another aspect of the example, additional composite anodes layers may be formed, wherein the composite anode slurry formation has a higher anolyte mass percentage than that used to form the previous layer.

In yet another aspect of the example, an analyte gradient composite anode structure may be partially or fully dried to remove the solvent. Alternatively, each composite anode layer may be partially or fully dried prior to the formation of the next layer, or a combination thereof. In yet another alternative, the anolyte gradient composite anode structure may not be dried.

In yet another aspect of the example, an anolyte gradient composite anode structure may be hot calendered to partially or fully densify the gradient structure. Alternatively, each composite anode layer may be hot calendered to partially or fully densify the layer prior to the formation of the next layer, or a combination thereof. In yet another alternative, the anolyte gradient composite anode structure may not be hot calendered.

In yet another aspect of the example, a solid-state electrolyte layer may be formed onto the anolyte gradient composite anode structure.

In yet another aspect of the example, a solid-state electrolyte layer may be partially or fully dried to remove the solvent. Alternatively, a solid-state electrolyte layer may not be dried.

In yet another aspect of the example, a solid-state electrolyte layer may be hot calendered to partially or fully densify the ionic conducting layer. Alternatively, a solid-state electrolyte layer may not be calendered.

In yet another aspect of the example, a first composite cathode layer may be formed onto the solid-state electrolyte layer using a first composite cathode slurry formulation with a high catholyte mass percentage.

In yet another aspect of the example, a second composite cathode layer may be formed onto the first composite cathode layer using a second composite cathode slurry formulation with a lower catholyte mass percentage than the first composite cathode slurry formulation.

In yet another aspect of the example, a third composite cathode layer may be formed onto the second composite cathode layer using a third composite cathode slurry formulation with a lower catholyte mass percentage than the second composite cathode slurry formulation.

In yet another aspect of the example, additional composite cathode layers may be formed, wherein the composite cathode slurry formation has a lower catholyte mass percentage than that used to form the previous layer

In yet another aspect of the example, a catholyte gradient composite cathode structure may be partially or fully dried to remove the solvent. Alternatively, each composite cathode layer may be partially or fully dried separately prior to the formation of the next layer, or a combination thereof. In yet another alternative, the catholyte gradient composite cathode structure may not be dried.

In yet another aspect of the example, a catholyte gradient composite cathode structure may be hot calendered to partially or fully densify the gradient structure. Alternatively, each composite cathode layer may be hot calendered to partially or fully densify the layer prior to the formation of the next layer, or a combination thereof. In yet another alternative, the catholyte gradient composite may not be hot calendered.

In yet another aspect of the example, a gradient solid-state battery layer may be dried one or more times after its formation and then hot calendered.

In yet another aspect of the example, a positive current collector may be laminated onto the third or last composite cathode layer.

The present disclosure relates to a solvent-free manufacturing method for gradient solid-state battery layers.

A high-throughput solvent-free manufacturing method may be defined as an all-dry processing method without the use of any liquid-based solvents.

A high-throughput solvent-free manufacturing method may enable binder-free solid-state lithium battery architectures to be constructed, reducing cell impedance and enabling high power rates.

A high-throughput solvent-free manufacturing method may eliminate drying and calendering steps using in solvent-based manufacturing.

A high-throughput solvent-free manufacturing method may be used to form a catholyte gradient composite cathode structure, wherein the composite cathode formulation may be in a dry powder form.

A high-throughput solvent-free manufacturing method may enable intimate contact between the composite cathode layers, resulting in lower cell impedance, and higher power rates.

A high-throughput solvent-free manufacturing method may be used to form an anolyte gradient composite anode structure, wherein the composite anode formulation may be in a dry powder form.

A high-throughput solvent-free manufacturing method may enable intimate contact between the composite anodes layers, resulting in lower cell impedance, and higher power rates.

A high-throughput solvent-free manufacturing method may be used to form a solid-state electrolyte layer, wherein the solid-state electrolyte formulation may be in a dry powder form.

A solid-state electrolyte layer may be formed onto a catholyte gradient composite cathode structure using a high-throughput solvent-free manufacturing method. A high-throughput solvent-free manufacturing method may enable intimate contact with the catholyte gradient composite cathode structure, resulting in lower cell impedance, and higher power rates.

A solid-state electrolyte layer may be formed onto an anolyte gradient composite anode structure using a high-throughput solvent-free manufacturing method. A high-throughput solvent-free manufacturing method may enable intimate contact with the anolyte gradient composite anode structure, resulting in lower cell impedance, and higher power rates.

A high-throughput solvent-free manufacturing method may be done under vacuum or in a dry or inert environment such as argon or nitrogen.

A high-throughput solvent-free manufacturing method may be done in a roll-to-roll process.

A high-throughput solvent-free manufacturing method may be done manually or thorough an automated process controlled via hard wire or WIFI. An automated process may use robotic arms throughout a roll-to-roll process.

An example of a high-throughput solvent-free manufacturing method may include a cold spray deposition; wherein dry powder formulations are cold sprayed to form a gradient solid-state battery layer. Types of cold spray deposition may include, for example, high-pressure and low-pressure cold spray depositions.

In an aspect of the example, a cold spray approach may be used to manufacture a catholyte gradient composite cathode structure onto a positive current collector, wherein each composite cathode layer may be formed one layer at a time using one or more cold spray guns. Composite cathode layers may have a thickness in the range of 0.1≤t≤1000 μm, with a preferred range of 1≤t≤100 μm.

In another aspect of the example, a cold spray approach may be used to manufacture a solid-state electrolyte layer onto a catholyte gradient composite cathode structure, wherein one or more cold spray guns are used to form the ionic conducting layer. Solid-state electrolyte layer may have a thickness in the range of 0.1≤t≤500 μm, with a preferred range of 1≤t≤50 μm.

In yet another aspect of the example, a cold spray approach may be used to manufacture an anolyte gradient composite anode structure onto a solid-state electrolyte layer, wherein each composite anode layer may be formed one layer at a time using one or more cold spray guns. Composite anode layers may have a thickness in the range of 0.1≤t≤1000 μm, with a preferred range of 1≤t≤100 μm.

In yet another aspect of the example, a cold spray approach may be used to manufacture an anolyte gradient composite anode structure onto a negative current collector, wherein each composite anode layer may be formed one layer at a time using one or more cold spray guns. Composite cathode layers may have a thickness in the range of 0.1≤t≤1000 μm, with a preferred range of 1≤t≤100 μm.

In yet another aspect of the example, a cold spray approach may be used to manufacture a solid-state electrolyte layer onto an anolyte gradient composite anode structure, wherein one or more cold spray guns are used to form the ionic conducting layer. The solid-state electrolyte layer may have a thickness in the range of 0.1≤t≤500 μm, with a preferred range of 1≤t≤50 μm.

In yet another aspect of the example, a cold spray approach may be used to manufacture a catholyte gradient composite cathode structure onto a solid-state electrolyte layer, wherein each composite cathode layer may be formed one layer at a time using one or more cold spray guns. Composite cathode layers may have a thickness in the range of 0.1≤t≤1000 μm, with a preferred range of 1≤t≤100 μm.

In yet another aspect of the example, the one or more cold spray guns may remain stationary or move in a controlled raster like fashion to form the gradient solid-state battery layer

In yet another aspect of the example, a cold spray approach may deform composite cathode, solid-state electrolyte, and composite anode powders upon impact due to the high kinetic energy/velocity of the particles, causing plastic deformation (i.e., peening effect) which may reduce cell impedance.

Another example of a high-throughput solvent-free manufacturing process may include a thermal spray deposition; wherein dry powder formulations are thermally sprayed to form a gradient solid-state battery layer. Types of thermal spray deposition includes, for example, flame spray, plasma spray, wire arc spray, high velocity oxygen fuel spraying, induction assisted, etc.

In an aspect of the example, a thermal spray approach may be used to manufacture a catholyte gradient composite cathode structure onto a positive current collector, wherein each composite cathode layer may be formed one layer at a time using one or more thermal spray guns. Composite cathode layers may have a thickness in the range of 0.1≤t≤1000 μm, with a preferred range of 1≤t≤100 μm.

In another aspect of the example, a thermal spray approach may be used to manufacture a solid-state electrolyte layer onto a catholyte gradient composite cathode structure, wherein one or more thermal spray guns are used to form the ionic conducting layer. Solid-state electrolyte layer may have a thickness in the range of 0.1≤t≤500 μm, with a preferred range of 1≤t≤50 μm.

In yet another aspect of the example, a thermal spray approach may be used to manufacture an anolyte gradient composite anode structure onto a solid-state electrolyte layer, wherein each composite anode layer may be formed one layer at a time using one or more thermal spray guns. Composite anode layers may have a thickness in the range of 0.1≤t≤1000 μm, with a preferred range of 1≤t≤100 μm.

In yet another aspect of the example, a thermal spray approach may be used to manufacture an anolyte gradient composite anode structure onto a negative current collector, wherein each composite anode layer may be formed one layer at a time using one or more thermal spray guns. Composite cathode layers may have a thickness in the range of 0.1≤t≤1000 μm, with a preferred range of 1≤t≤100 μm.

In yet another aspect of the example, a thermal spray approach may be used to manufacture a solid-state electrolyte layer onto an anolyte gradient composite anode structure, wherein one or more thermal spray guns are used to form the ionic conducting layer. The solid-state electrolyte layer may have a thickness in the range of 0.1≤t≤500 μm, with a preferred range of 1≤t≤50 μm.

In yet another aspect of the example, a thermal spray approach may be used to manufacture a catholyte gradient composite cathode structure onto a solid-state electrolyte layer, wherein each composite cathode layer may be formed one layer at a time using one or more thermal spray guns. Composite cathode layers may have a thickness in the range of 0.1≤t≤1000 μm, with a preferred range of 1≤t≤100 μm.

In yet another aspect of the example, the one or more thermal spray guns may remain stationary or move in a controlled raster like fashion to form the gradient solid-state battery layer.

In yet another aspect of the example, a thermal spray approach may deform composite cathode, solid-state electrolyte, and composite anode powders due to the high temperature of the thermal spray process, forming a densely layered or lamella structure upon impact which may reduce cell impedance.

In yet another aspect of the example, the temperature of the thermal spray process may be tuned to control the microstructure of the gradient solid-state battery. For example, high temperatures may be used to form a more densely layered or lamella structure. Alternatively, low temperature may be used to form a more granular structure.

Yet another example of a high-throughput solvent-free manufacturing process may include a laser assisted additive manufacturing processing, wherein dry powder formulations are deposited (via powder aerosol deposition or electrostatic spray deposition), and heat treated with a laser to weld particles and layers together, forming a gradient solid-state battery layer.

In an aspect of the example, a laser assisted approach may be used to manufacture a catholyte gradient composite cathode structure onto a positive current collector, wherein dry composite cathode powder formulations are sprayed one at a time with one or more aerosol or electrostatic spray nozzles and welded together with one or more lasers to form the catholyte gradient composite cathode structure. Composite cathode layers may have a thickness in the range of 0.1≤t≤1000 μm, with a preferred range of 1≤t≤100 μm.

In another aspect of the example, a laser assisted approach may be used to manufacture a solid-state electrolyte layer onto a catholyte gradient composite cathode structure, wherein a dry solid-state electrolyte powder formulation may be sprayed with one or more aerosol or electrostatic spray nozzles and welded together with one or more lasers to form the solid-state electrolyte layer. Solid-state electrolyte layer may have a thickness in the range of 0.1≤t≤500 μm, with a preferred range of 1≤t≤50 μm.

In yet another aspect of the example, a laser assisted approach may be used to manufacture an anolyte gradient composite cathode structure onto a solid-state electrolyte layer, wherein dry composite anode powder formulations are sprayed one at a time with one or more aerosol or electrostatic spray nozzles and welded together with one or more lasers to form the anolyte gradient composite anode structure. Composite anode layers may have a thickness in the range of 0.1≤t≤1000 μm, with a preferred range of 1≤t≤100 μm.

In yet another aspect of the example, a laser assisted approach may be used to manufacture an anolyte gradient composite anode structure onto a negative current collector, wherein dry composite anode powder formulations are sprayed one at a time with one or more aerosol or electrostatic spray nozzles and welded together with one or more lasers to form the anolyte gradient composite anode structure. Composite anode layers may have a thickness in the range of 0.1≤t≤1000 μm, with a preferred range of 1≤t≤100 μm.

In yet another aspect of the example, a laser assisted approach may be used to manufacture a solid-state electrolyte layer onto an anolyte gradient composite anode structure, wherein a dry solid-state electrolyte powder formulation may be sprayed with one or more aerosol or electrostatic spray nozzles and welded together with one or more lasers to form the solid-state electrolyte layer. Solid-state electrolyte layer may have a thickness in the range of 0.1≤t≤500 μm, with a preferred range of 1≤t≤50 μm.

In yet another aspect of the example, a laser assisted approach may be used to manufacture a catholyte gradient composite cathode structure onto a solid-state electrolyte layer, wherein dry composite cathode powder formulations are sprayed one at a time with one or more aerosol or electrostatic spray nozzles and welded together with one or more lasers to form the catholyte gradient composite cathode structure. Composite cathode layers may have a thickness in the range of 0.1≤t≤1000 μm, with a preferred range of 1≤t≤100 μm.

In yet another aspect of the example, the one or more aerosol or electrostatic spray nozzles and the one or more lasers may remain stationary or move in a controlled raster like fashion to form the gradient solid-state battery layer

Yet another example of a high-throughput solvent-free manufacturing process may include a laser assisted additive manufacturing processing, wherein dry powder formulations are deposited 3D printing, and heat treated with a laser to weld particles and layers together, forming a gradient solid-state battery layer.

In an aspect of the example, a laser assisted approach may be used to manufacture a catholyte gradient composite cathode structure onto a positive current collector, wherein dry composite cathode powder formulations are sprayed one at a time with one or more 3D printing heads and welded together with one or more lasers to form the catholyte gradient composite cathode structure. Composite cathode layers may have a thickness in the range of 0.1≤t≤1000 μm, with a preferred range of 1≤t≤100 μm.

In another aspect of the example, a laser assisted approach may be used to manufacture a solid-state electrolyte layer onto a catholyte gradient composite cathode structure, wherein a dry solid-state electrolyte powder formulation may be sprayed with one or more 3D printing heads and welded together with one or more lasers to form the solid-state electrolyte layer. Solid-state electrolyte layer may have a thickness in the range of 0.1≤t≤500 μm, with a preferred range of 1≤t≤50 μm.

In yet another aspect of the example, a laser assisted approach may be used to manufacture an anolyte gradient composite cathode structure onto a solid-state electrolyte layer, wherein dry composite anode powder formulations are sprayed one at a time with one or more 3D printing heads and welded together with one or more lasers to form the anolyte gradient composite anode structure. Composite anode layers may have a thickness in the range of 0.1≤t≤1000 μm, with a preferred range of 1≤t≤100 μm.

In yet another aspect of the example, a laser assisted approach may be used to manufacture an anolyte gradient composite anode structure onto a negative current collector, wherein dry composite anode powder formulations are sprayed one at a time with one or more 3D printing heads and welded together with one or more lasers to form the anolyte gradient composite anode structure. Composite anode layers may have a thickness in the range of 0.1≤t≤1000 μm, with a preferred range of 1≤t≤100 μm.

In yet another aspect of the example, a laser assisted approach may be used to manufacture a solid-state electrolyte layer onto an anolyte gradient composite anode structure, wherein a dry solid-state electrolyte powder formulation may be sprayed with one or more 3D printing heads and welded together with one or more lasers to form the solid-state electrolyte layer. Solid-state electrolyte layer may have a thickness in the range of 0.1≤t≤500 μm, with a preferred range of 1≤t≤50 μm.

In yet another aspect of the example, a laser assisted approach may be used to manufacture a catholyte gradient composite cathode structure onto a solid-state electrolyte layer, wherein dry composite cathode powder formulations are sprayed one at a time with one or more 3D printing heads and welded together with one or more lasers to form the catholyte gradient composite cathode structure. Composite cathode layers may have a thickness in the range of 0.1≤t≤1000 μm, with a preferred range of 1≤t≤100 μm.

In yet another aspect of the example, the one or more 3D printing heads and the one or more lasers may remain stationary or move in a controlled raster like fashion to form the gradient solid-state battery layer

In an example, a catholyte gradient composite cathode structure may be formed onto a positive current collector followed by a solid-state electrolyte layer and an anolyte gradient composite anode structure using an aforementioned high-throughput solvent-free manufacturing approach.

In an aspect of the example, a first composite cathode layer may be formed onto a positive current collector using a first dry composite cathode powder formulation with a low catholyte mass percentage.

In another aspect of the example, a second composite cathode layer may be formed onto a first composite cathode layer using a second dry composite cathode powder formulation with a higher catholyte mass percentage than the first dry composite cathode powder formulation.

In yet another aspect of the example, a third composite cathode layer may be formed onto a second composite cathode layer using a third dry composite cathode powder formulation with a higher catholyte mass percentage than the second dry composite cathode powder formulation, forming the catholyte gradient composite cathode structure.

In yet another aspect of the example, additional composite cathode layers may be formed, wherein the dry composite cathode powder formulation has a higher catholyte mass percentage than that used to form the previous layer.

In yet another aspect of the example, a solid-state electrolyte layer may be formed onto the catholyte gradient composite cathode structure using a dry solid-state electrolyte powder formulation.

In yet another aspect of the example, a first composite anode layer may be formed onto the solid-state electrolyte layer using a dry composite anode powder formulation with a high anolyte mass percentage.

In yet another aspect of the example, a second composite anode layer may be formed onto the first composite anode layer using a dry composite anode powder formulation with a lower anolyte mass percentage than the first dry composite anode powder formulation.

In yet another aspect of the example, a third composite anode layer may be formed onto the second composite anode layer using a dry composite anode powder formulation with a lower anolyte mass percentage than the second dry composite cathode powder formulation.

In yet another aspect of the example, additional composite anodes layers may be formed, wherein the dry composite anode powder formulation has a lower anolyte mass percentage than that used to form the previous layer.

In yet another aspect of the example, a negative current collector may be laminated onto the third or last composite anode layer.

In another example, an anolyte gradient composite anode structure may be formed onto a negative current collector followed by a solid-state electrolyte layer and a catholyte gradient composite cathode structure using an aforementioned high-throughput solvent-free manufacturing approach.

In an aspect of the example, a first composite anode layer may be formed onto a negative current collector using a first dry composite anode powder formulation with a low anolyte mass percentage.

In another aspect of the example, a second composite anode layer may be formed onto a first composite anode layer using a second dry composite anode powder formulation with a higher anolyte mass percentage than the first dry composite anode powder formulation.

In yet another aspect of the example, a third composite anode layer may be formed onto a second composite anode layer using a third dry composite anode powder formulation with a higher anolyte mass percentage than the second dry composite anode powder formulation, forming an anolyte gradient composite anode structure.

In yet another aspect of the example, additional composite anodes layers may be formed, wherein the dry composite anode powder formulation has a higher anolyte mass percentage than that used to form the previous layer.

In yet another aspect of the example, a solid-state electrolyte layer may be formed onto the anolyte gradient composite anode structure using a dry solid-state electrolyte powder formulation.

In yet another aspect of the example, a first composite cathode layer may be formed onto the solid-state electrolyte layer using a first dry composite cathode powder formulation with a high catholyte mass percentage.

In yet another aspect of the example, a second composite cathode layer may be formed onto the first composite cathode layer using a second dry composite cathode powder formulation with a lower catholyte mass percentage than the first dry composite cathode powder formulation.

In yet another aspect of the example, a third composite cathode layer may be formed onto the second composite cathode layer using a third dry composite cathode powder formulation with a lower catholyte mass percentage than the second dry composite cathode powder formulation.

In yet another aspect of the example, additional composite cathode layers may be formed, wherein the dry composite cathode powder formation has a lower catholyte mass percentage than that used to form the previous layer

In yet another aspect of the example, a positive current collector may be laminated onto the third or last composite cathode layer.

The present disclosure relates to a solid-state lithium battery.

A solid-state lithium battery with a may be comprised of one or more gradient solid-state battery layers, forming a gradient architecture.

A first gradient solid-state battery layer may be formed onto a positive current collector, wherein a catholyte gradient composite cathode structure may be formed first followed by a solid-state electrolyte layer and an anolyte gradient composite anode structure.

In such an instance, a second gradient solid-state battery layer may be formed onto the back side of the positive current collector, wherein a second catholyte gradient composite cathode may be formed first followed by a solid-state electrolyte layer and an anolyte gradient composite anode structure, forming a double gradient solid-state battery layer.

Alternatively, a first gradient solid-state battery layer may be formed onto a negative current collector, wherein an anolyte gradient composite anode structure may be formed first followed by a solid-state electrolyte layer and a catholyte gradient composite cathode structure.

In such an instance, a second gradient solid-state battery layer may be formed onto the back side of the negative current collector, wherein a second anolyte gradient composite anode may be formed first followed by a solid-state electrolyte layer and a catholyte gradient composite cathode structure, forming a double gradient solid-state battery layer.

In yet another alternative, a first gradient solid-state battery layer may be formed onto a positive current collector, wherein a catholyte gradient composite cathode structure may be formed first followed by a solid-state electrolyte layer, an anolyte gradient composite anode structure, and a negative current collector laminated on top.

In such an instance, a second gradient solid-state battery layer may be formed onto the top of the negative current collector, wherein a second anolyte gradient composite anode layer may be formed first followed by a solid-state electrolyte layer and a catholyte gradient composite cathode structure, forming a double gradient solid-state battery layer.

In yet another alternative, a first gradient solid-state battery layer may be formed onto a negative current collector, wherein an anolyte gradient composite anode structure may be formed first followed by a solid-state electrolyte layer, a catholyte gradient composite cathode structure, and a positive current collector laminated on top.

In such an instance, a second gradient solid-state battery layer may be formed onto the top of the positive current collector, wherein a second catholyte gradient composite cathode layer may be formed first followed by a solid-state electrolyte layer and an anolyte gradient composite anode structure, forming a double gradient solid-state battery layer.

Positive current collectors may include, for example, aluminum foil, aluminum mesh, aluminum foam, titanium foil, titanium mesh, titanium foam, nickel foil, nickel mesh, nickel foam, etc.

Negative current collectors may include, for example, cooper foil, copper mesh, copper foam, stainless steel foil, stainless steel mesh, stainless steel foam, etc.

A solid-state lithium battery may be comprised of one or more double gradient solid-state battery layers, forming a multi-layered solid-state lithium battery.

A single or multi-layered solid-state lithium battery may be in the form of a coin cell, button cull, cylindrical cell, or pouch cell.

A single or multi-layered solid-state lithium battery may have a capacity in the range of 0.01≤A≤10000 Ah, with a preferred range of 0.2≤A≤150 Ah.

In some instances, a solid-state lithium battery may be comprised of gradient solid-state battery layers with a catholyte gradient composite cathode structure and a non-gradient composite anode structure.

In other instances, a solid-state lithium battery may be comprised of gradient solid-state battery layers with a catholyte gradient composite cathode structure and a lithium or lithium-alloy metal film as the anode, forming what is referred to in the art as a solid-state lithium metal battery.

In yet other instances, a solid-state lithium battery may be comprised of gradient solid-state battery layers with a catholyte gradient composite cathode structure and no anode structure, forming what is referred to in the art as a solid-state anodeless lithium battery.

In yet other instances, a solid-state lithium battery may be comprised of gradient solid-state battery layers with an anolyte gradient composite anode structure and a non-gradient composite cathode structure.

The drawing of the present disclosure further describes examples of gradient solid-state battery layers, solid-state batteries comprising one or more gradient solid-state battery layers, and manufacturing thereof.

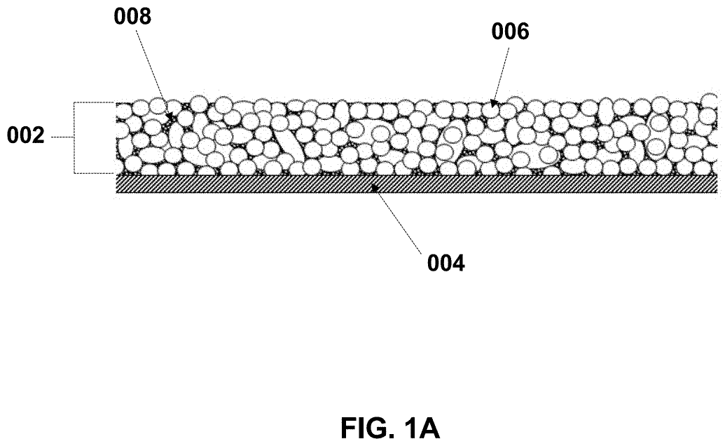

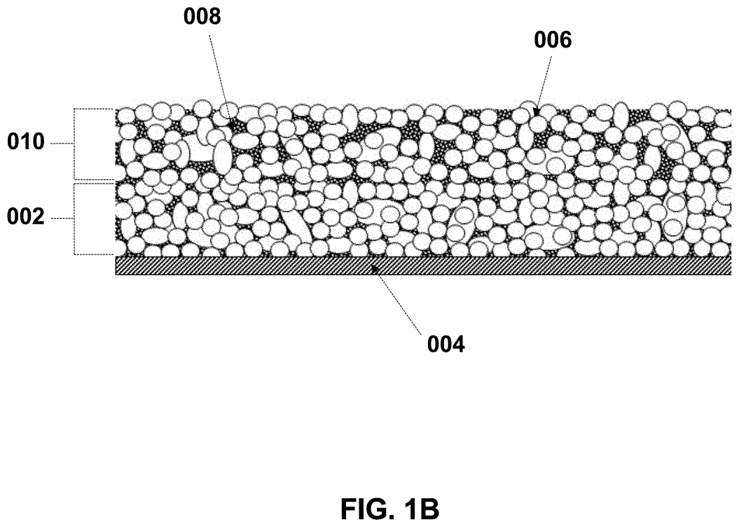

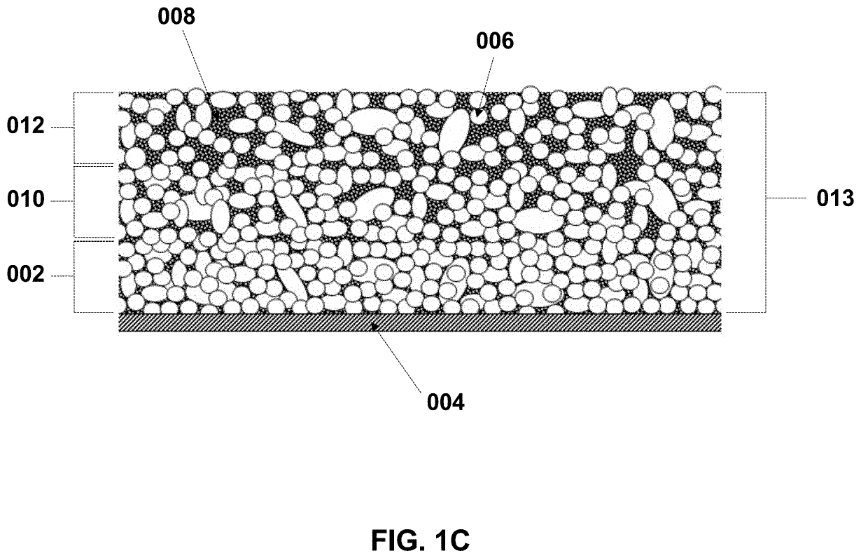

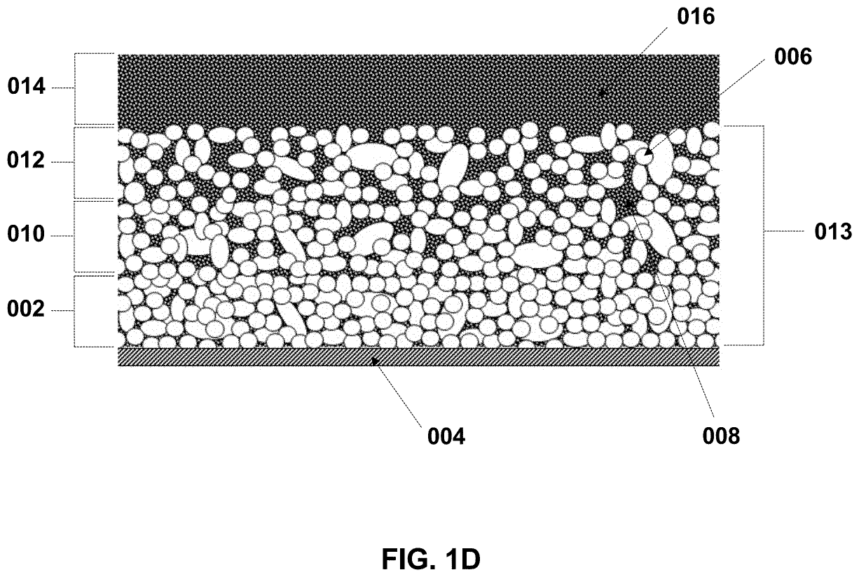

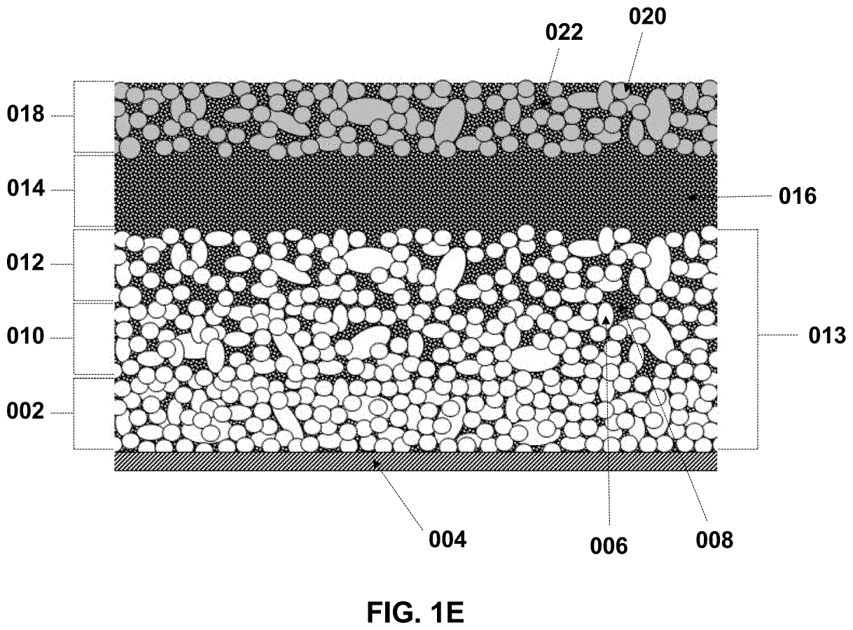

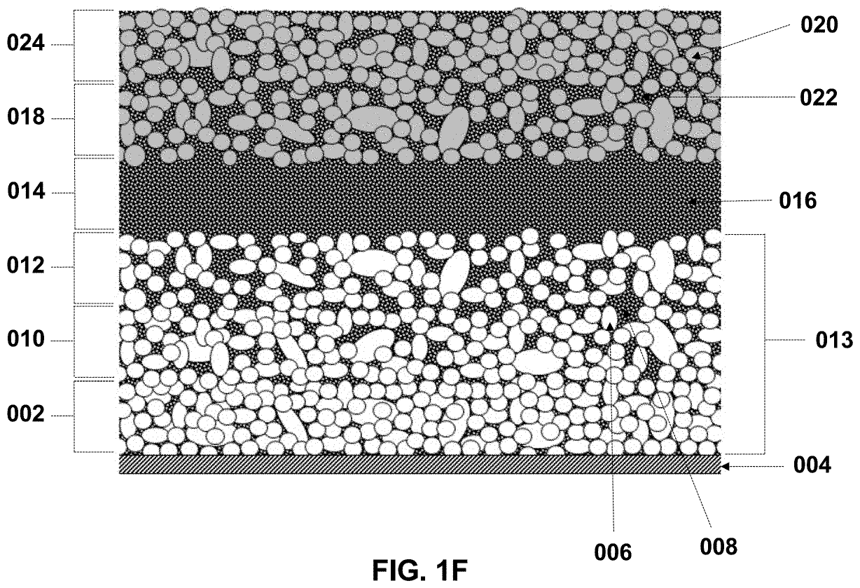

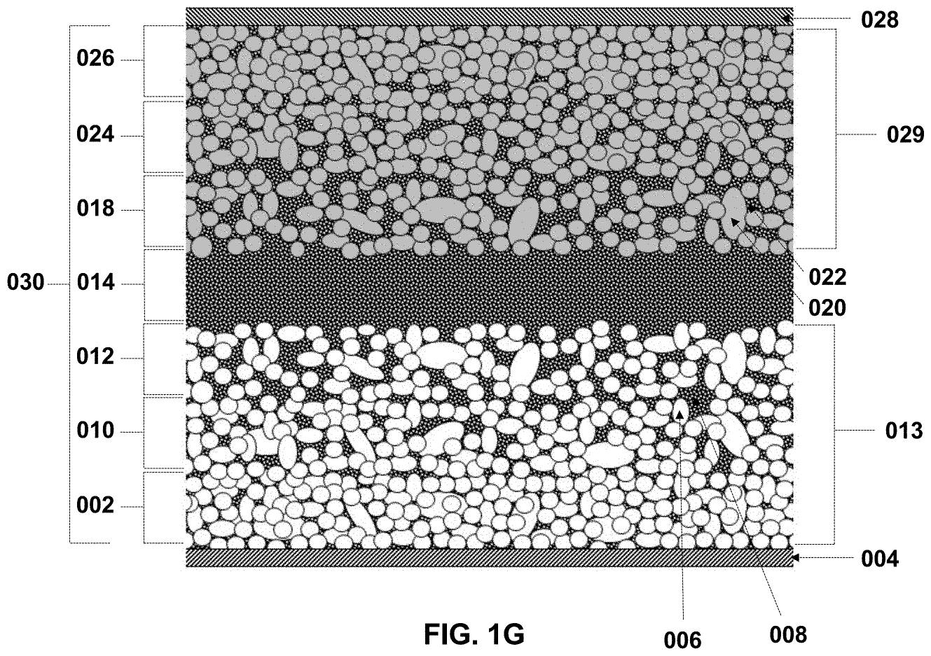

FIG. 1A: A schematic illustration of a first composite cathode layer (002) formed onto a positive current collector (004), wherein the first composite cathode layer (002) has a high active cathode (006) loading and a low catholyte (008) mass percentage.

Alternatively, the schematic illustration in FIG. 1A may include a first composite anode layer (002) formed onto a negative current collector (004), wherein the first composite anode layer (002) has a high active anode (006) loading and a low anolyte (008) mass percentage.

FIG. 1B: A schematic illustration of a second composite cathode layer (010) formed onto a first composite cathode layer (002). The second composite cathode layer is formulated with a lower active cathode (006) loading and a higher catholyte (008) mass percentage with respect to the first composite cathode layer. A first composite cathode layer (002) is formed onto a positive current collector (004).

Alternatively, the schematic illustration in FIG. 1B may include a second composite anode layer (010) formed onto a first composite anode layer (002). The second composite anode layer is formulated with a lower active anode (006) loading and a higher anolyte (008) mass percentage with respect to the first composite anode layer. A first composite anode layer (002) is formed onto a negative current collector (004).

FIG. 1C: A schematic illustration of a third composite cathode layer (012) formed onto a second composite cathode layer (010). The third composite cathode layer is formulated with a lower active cathode (006) loading and a higher catholyte (008) mass percentage with respect to the second composite cathode layer. The second composite cathode layer (010) is formed onto a first composite cathode layer (002) and is formulated with a lower active cathode (006) loading and a higher catholyte (008) mass percentage with respect to the first composite anode layer, forming a catholyte gradient composite cathode structure (013). A first composite cathode layer (002) is formed onto a positive current collector (004).

Alternatively, the schematic illustration in FIG. 1C may include a third composite anode layer (012) formed onto a second composite anode layer (010). The third composite anode layer is formulated with a lower active anode (006) loading and a higher anolyte (008) mass percentage with respect to the second composite anode layer. The second composite anode layer (010) is formed onto a first composite anode layer (002) and is formulated with a lower active anode (006) loading and a higher anolyte (008) mass percentage with respect to the first composite anode layer, forming an anolyte gradient composite anode structure (013). A first composite anode layer (002) is formed onto a negative current collector (004).

FIG. 1D: A schematic illustration of a solid-state electrolyte layer (014) formed onto a catholyte gradient composite cathode structure (013) comprising a first (002), second (010), and third (012) composite cathode layer. Each layer comprises of an active cathode (006) loading and a catholyte (008) mass percentage described in FIGS. 1A-C. The catholyte gradient composite cathode structure (013) is formed onto a positive current collector (004).

Alternatively, the schematic illustration in FIG. 1D may include a solid-state electrolyte layer (014) formed onto an anolyte gradient composite anode structure (013) comprising a first (002), second (010), and third (012) composite anode layer. Each layer comprises of an active anode (006) loading and an anolyte (008) mass percentage described in FIGS. 1A-C. The anolyte gradient composite anode structure (013) is formed onto a negative current collector (004).

FIG. 1E: A schematic illustration of a first composite anode layer (018) formed onto a solid-state electrolyte layer (014) comprising of solid-state ionic conductive materials (016). A first composite anode layer (018) comprises of a low active anode (020) loading and a high anolyte (022) mass percentage. The solid-state electrolyte layer (014) is formed onto a catholyte gradient composite cathode structure (013) comprising a first (002), second (010), and third (012) composite cathode layer. Each layer comprises of an active cathode (006) loading and a catholyte (008) mass percentage described in FIGS. 1A-C. The catholyte gradient composite cathode structure (013) is formed onto a positive current collector (004).

Alternatively, the schematic illustration in FIG. 1E may include a first composite cathode layer (018) formed onto a solid-state electrolyte layer (014) comprising of solid-state ionic conductive materials (016). A first composite cathode layer (018) comprises of a low active cathode (020) loading and a high catholyte (022) mass percentage. The solid-state electrolyte layer (014) is formed onto an anolyte gradient composite anode structure (013) comprising a first (002), second (010), and third (012) composite anode layer. Each layer comprises of an active anode (006) loading and an anolyte (008) mass percentages described in FIGS. 1A-C. The anolyte gradient composite anode structure (013) is formed onto a negative current collector (004).

FIG. 1F: A schematic illustration of a second composite anode layer (024) formed onto a first composite anode layer (018). The second composite anode layer is formulated with a higher active anode (020) loading and lower anolyte (022) mass percentage with respect to the first composite anode layer (018). The first composite anode layer (018) formed onto a solid-state electrolyte layer (014) comprising of solid-state ionic conductive materials (016). The solid-state electrolyte layer (014) is formed onto a catholyte gradient composite cathode structure (013) comprising a first (002), second (010), and third (012) composite cathode layer. Each layer comprises of an active cathode (006) loading and a catholyte (008) mass percentage described in FIGS. 1A-C. The catholyte gradient composite cathode structure (013) is formed onto a positive current collector (004)

Alternatively, the schematic illustration in FIG. 1F may include a second composite cathode layer (024) formed onto a first composite cathode layer (018). The second composite cathode layer is formulated with a higher active cathode (020) loading and lower catholyte (022) mass percentage with respect to the first composite cathode layer (018). The first composite cathode layer (018) formed onto a solid-state electrolyte layer (014) comprising of solid-state ionic conductive materials (016). The solid-state electrolyte layer (014) is formed onto an anolyte gradient composite anode structure (013) comprising a first (002), second (010), and third (012) composite anode layer. Each layer comprises of an active anode (006) loading and an anolyte (008) mass percentage described in FIGS. 1A-C. The anolyte gradient composite anode structure (013) is formed onto a negative current collector (004)

FIG. 1G: A schematic illustration of a first gradient solid-state battery layer (030) comprising an anolyte gradient composite anode structure (029) and a catholyte gradient composite cathode structure (013) separated by a solid-state electrolyte layer (014). The anolyte gradient composite anode structure (029) comprises a first (018), second (024), and third (026) composite anode layer, wherein the third composite anode layer (026) is formed onto the second composite anode layer (024) and has a higher active anode (020) loading and a lower anolyte (022) mass percentage with respect to the second composite anode layer (024). The second composite anode layer (024) is formed onto the first composite anode layer (018) and has a higher active anode (020) loading and a lower anolyte (022) mass percentage with respect to the first composite anode layer (018). The first composite anode layer (018) is formed onto a solid-state electrolyte layer (014). The solid-state electrolyte layer (014) is formed onto a catholyte gradient composite cathode structure (013) comprising a first (002), second (010), and third (012) composite cathode layer. Each layer comprises of an active cathode (006) loading and a catholyte (008) mass percentage described in FIGS. 1A-C. The catholyte gradient composite cathode structure (013) is formed onto a positive current collector (004). The anolyte gradient composite anode structure (029) is laminated with a negative current collector (028).

Alternatively, the schematic illustration in FIG. 1G may include a first gradient solid-state battery layer (030) comprising a catholyte gradient composite cathode structure (029) and an anolyte gradient composite anode structure (013) separated by a solid-state electrolyte layer (014). The catholyte gradient composite cathode structure (029) comprises a first (018), second (024), and third (026) composite cathode layer, wherein the third composite cathode layer (026) is formed onto the second composite cathode layer (024) and has a higher active cathode (020) loading and a lower catholyte (022) mass percentage with respect to the second composite cathode layer (024). The second composite cathode layer (024) is formed onto the first composite cathode layer (018) and has a higher active cathode (020) loading and a lower catholyte (022) mass percentage with respect to the first composite cathode layer (018). The first composite cathode layer (018) is formed onto a solid-state electrolyte layer (014). The solid-state electrolyte layer (014) is formed onto an anolyte gradient composite anode structure (013) comprising a first (002), second (010), and third (012) composite anode layer. Each layer comprises of an active anode (006) loading and an anolyte (008) mass percentage described in FIGS. 1A-C. The anolyte gradient composite anode structure (013) is formed onto a negative current collector (004). The catholyte gradient composite cathode structure (029) is laminated with a positive current collector (028).

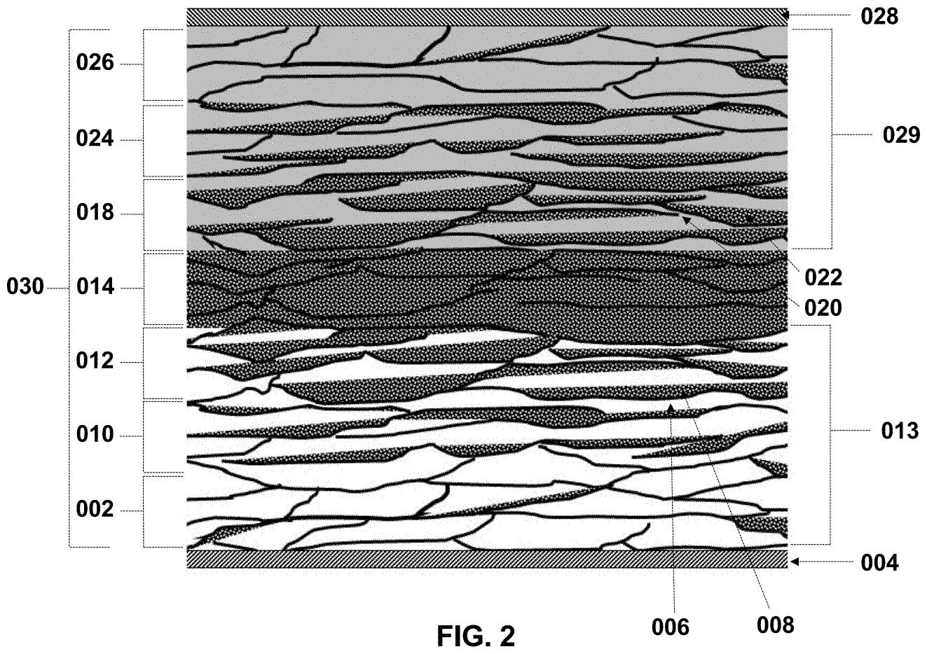

FIG. 2: A schematic illustration of a first gradient solid-state battery layer (030) processed using a high-throughput spray process to form a densely layered structure comprising an anolyte gradient composite anode structure (029) and a catholyte gradient composite cathode structure (013) separated by a solid-state electrolyte layer (014). The anolyte gradient composite anode structure (029) comprises a first (018), second (024), and third (026) composite anode layer, wherein the third composite anode layer (026) is formed onto the second composite anode layer (024) and has a higher active anode (020) loading and lower anolyte (022) mass percentage with respect to the second composite anode layer (024). The second composite anode layer (024) is formed onto the first composite anode layer (018) and has a higher active anode (020) loading and lower anolyte (022) mass percentage with respect to the first composite anode layer (018). The first composite anode layer (018) is formed onto a solid-state electrolyte layer (014). The solid-state electrolyte layer (014) is formed onto a catholyte gradient composite cathode structure (013) comprising a first (002), second (010), and third (012) composite cathode layer. Each layer comprises of an active cathode (006) loading and catholyte (008) mass percentage described in FIGS. 1A-C. The catholyte gradient composite cathode structure (013) is formed onto a positive current collector (004). The anolyte gradient composite anode structure (029) is laminated with a negative current collector (028).

Alternatively, the schematic illustration in FIG. 2 may include a first gradient solid-state battery layer (030) processed using a high-throughput spray process to form a densely layered structure comprising a catholyte gradient composite cathode structure (029) and an anolyte gradient composite anode structure (013) separated by a solid-state electrolyte layer (014). The catholyte gradient composite cathode structure (029) comprises a first (018), second (024), and third (026) composite cathode layer, wherein the third composite cathode layer (026) is formed onto the second composite cathode layer (024) and has a higher active cathode (020) loading and a lower catholyte (022) mass percentage with respect to the second composite cathode layer (024). The second composite cathode layer (024) is formed onto the first composite cathode layer (018) and has a higher active cathode (020) loading and a lower catholyte (022) mass percentage with respect to the first composite cathode layer (018). The first composite cathode layer (018) is formed onto a solid-state electrolyte layer (014). The solid-state electrolyte layer (014) is formed onto an anolyte gradient composite anode structure (013) comprising a first (002), second (010), and third (012) composite anode layer. Each layer comprises of an active anode (006) loading and an anolyte (008) mass percentage described in FIGS. 1A-C. The anolyte gradient composite anode structure (013) is formed onto a negative current collector (004). The catholyte gradient composite cathode structure (029) is laminated with a positive current collector (028).

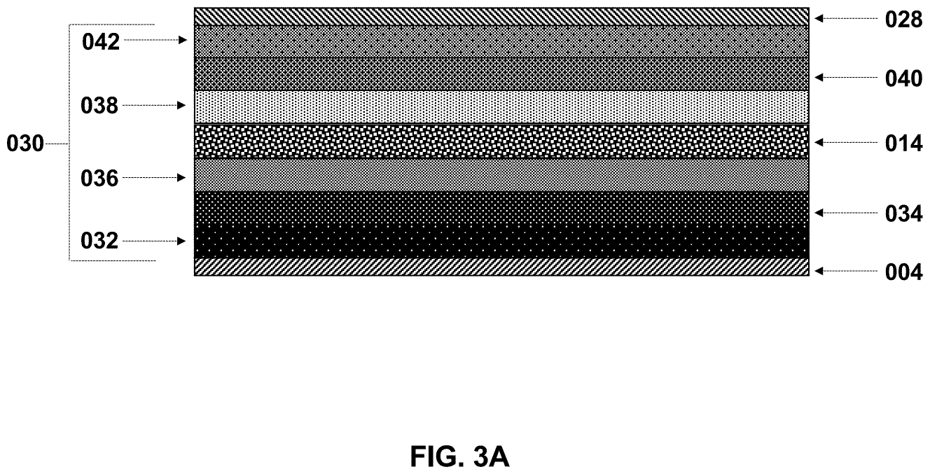

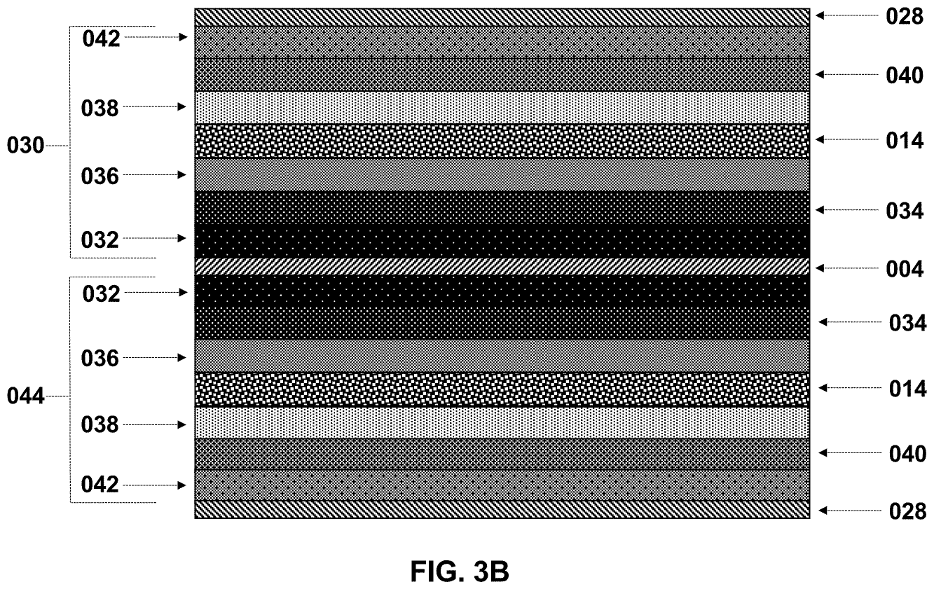

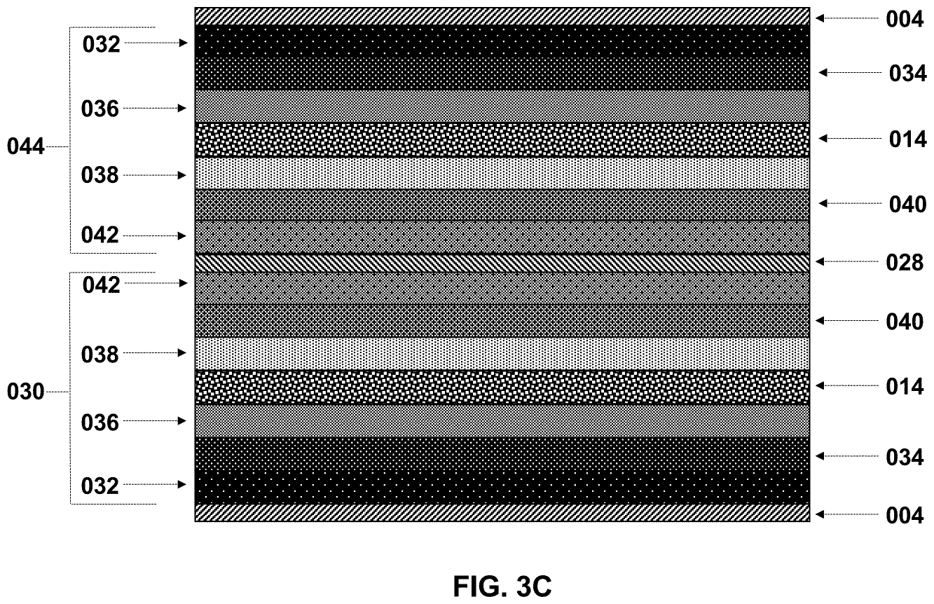

FIG. 3A: A schematic illustration of a first gradient solid-state battery layer (030), wherein a first composite cathode layer with a low catholyte mass percentage (032) is first formed onto a positive current collector (004). A second composite cathode layer with a higher catholyte mass percentage (034) is formed onto the first composite cathode layer (032). A third composite cathode layer with an even higher catholyte mass percentage (036) is formed onto the second composite cathode layer (034). A solid-state electrolyte layer (014) is formed onto the third composite cathode layer (036). A first composite anode layer with a high anolyte mass percentage (038) is formed onto the solid-state electrolyte layer (014). A second composite anode layer with a lower anolyte mass percentage (040) is formed onto the first composite anode layer (038). A third composite anode layer with an even lower anolyte mass percentage (042) is formed onto the second composite anode layer (040). A third composite anode layer (042) is laminated with a negative current collector (028).

FIG. 3B: A schematic illustration of a second gradient solid-state battery layer (044), wherein the second layer is formed onto the backside of the positive current collector (004) supporting the first gradient solid-state battery layer (030) from FIG. 3A. A first composite cathode layer with a low catholyte mass percentage (032) is first formed onto the backside of said positive current collector (004). A second composite cathode layer with a higher catholyte mass percentage (034) is formed onto said first composite cathode layer (032). A third composite cathode layer with an even higher catholyte mass percentage (036) is formed onto said second composite cathode layer (034). A solid-state electrolyte layer (014) is formed onto said third composite cathode layer (036). A first composite anode layer with a high anolyte mass percentage (038) is formed onto said solid-state electrolyte layer (014). A second composite anode layer with a lower anolyte mass percentage (040) is formed onto said first composite anode layer (038). A third composite anode layer with an even lower anolyte mass percentage (042) is formed onto said second composite anode layer (040). Said third composite anode layer (042) is laminated with a negative current collector (028).

FIG. 3C: A schematic illustration of a second gradient solid-state battery layer (044), wherein the second layer is formed onto the top of the laminated negative current collector (028) in FIG. 3A. A first composite anode layer with a low anolyte mass percentage (042) is first formed onto the top of said negative current collector (028). A second composite anode layer with a higher anolyte mass percentage (040) is formed onto said first composite anode layer (042). A third composite anode layer with an even higher anolyte mass percentage (038) is formed onto said second composite anode layer (040). A solid-state electrolyte layer (014) is formed onto said third composite anode layer (038). A first composite cathode layer with a high catholyte mass percentage (036) is formed onto said solid-state electrolyte layer (014). A second composite cathode layer with a lower catholyte mass percentage (034) is formed onto said first composite cathode layer (036). A third composite cathode layer with an even lower catholyte mass percentage (032) is formed onto said second composite cathode layer (036). Said third composite anode layer (032) is laminated with a positive current collector (004).

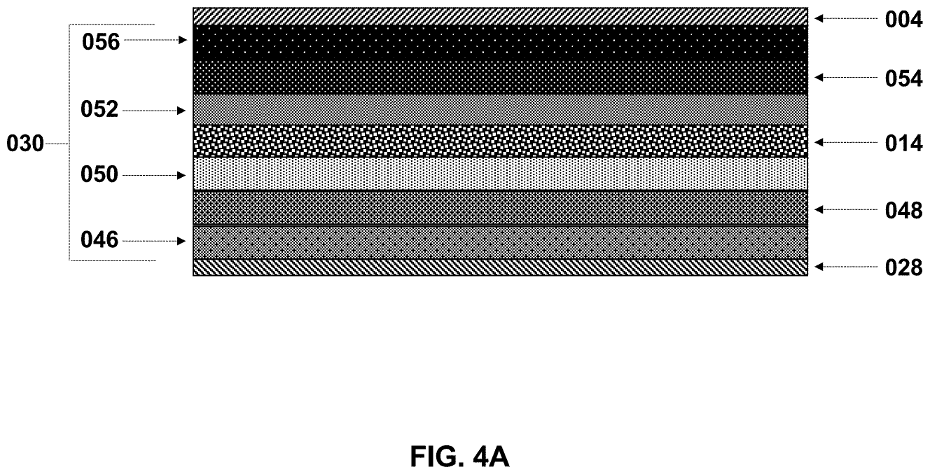

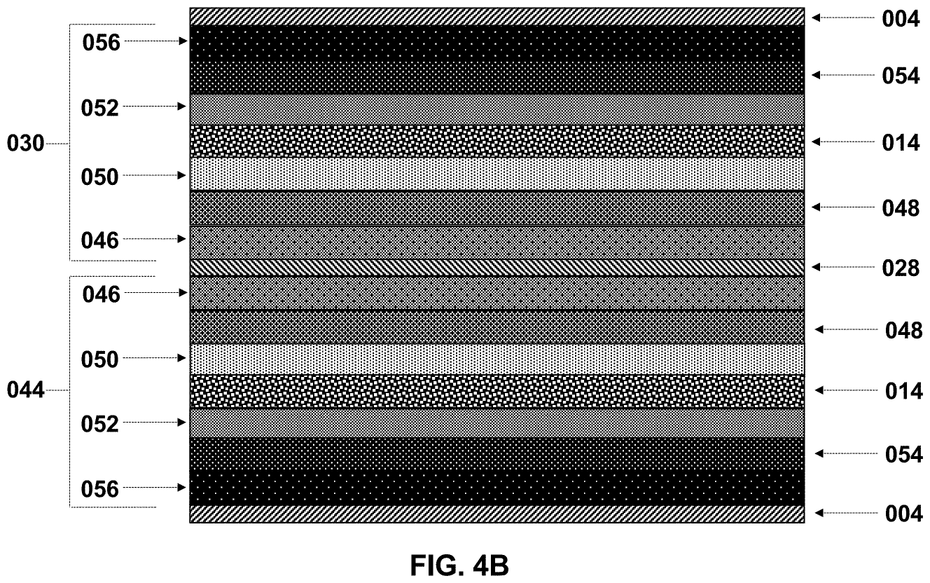

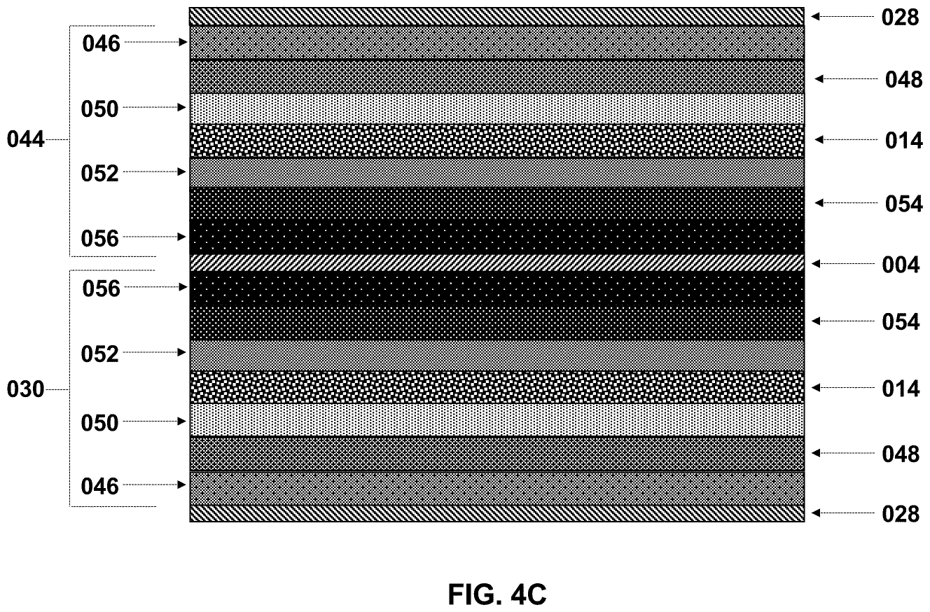

FIG. 4A: A schematic illustration of a first gradient solid-state battery layer (030), wherein a first composite anode layer with a low anolyte mass percentage (046) is first formed onto a negative current collector (028). A second composite anode layer with a higher anolyte mass percentage (048) is formed onto the first composite anode layer (046). A third composite anode layer with an even higher anolyte mass percentage (050) is formed onto the second composite anode layer (048). A solid-state electrolyte layer (014) is formed onto the third composite cathode layer (050). A first composite cathode layer with a high catholyte mass percentage (052) is formed onto the solid-state electrolyte layer (014). A second composite cathode layer with a lower catholyte mass percentage (054) is formed onto the first composite cathode layer (052). A third composite cathode layer with an even lower catholyte mass percentage (056) is formed onto the second composite cathode layer (054). A third composite cathode layer (056) is laminated with a positive current collector (004).

FIG. 4B: A schematic illustration of a second gradient solid-state battery layer (044), wherein the second layer is formed onto the backside of the negative current collector (028) supporting the first gradient solid-state battery layer (030) from FIG. 4A. A first composite anode layer with a low anolyte mass percentage (046) is first formed onto the backside of said negative current collector (028). A second composite anode layer with a higher anolyte mass percentage (048) is formed onto said first composite anode layer (046). A third composite anode layer with an even higher anolyte mass percentage (050) is formed onto said second composite anode layer (048). A solid-state electrolyte layer (014) is formed onto said third composite anode layer (050). A first composite cathode layer with a high catholyte mass percentage (052) is formed onto said solid-state electrolyte layer (014). A second composite cathode layer with a lower catholyte mass percentage (054) is formed onto said first composite cathode layer (052). A third composite cathode layer with an even lower catholyte mass percentage (056) is formed onto said second composite cathode layer (054). Said third composite cathode layer (056) is laminated with a positive current collector (004).

FIG. 4C: schematic illustration of a second gradient solid-state battery layer (044), wherein the second layer is formed onto the top side of the laminated positive current collector (004) in FIG. 4A. A first composite cathode layer with a low catholyte mass percentage (056) is first formed onto the top of said positive current collector (004). A second composite cathode layer with a higher catholyte mass percentage (054) is formed onto said first composite cathode layer (056). A third composite cathode layer with an even higher catholyte mass percentage (052) is formed onto said second composite cathode layer (054). A solid-state electrolyte layer (014) is formed onto said third composite cathode layer (052). A first composite anode layer with a high anolyte mass percentage (050) is formed onto said solid-state electrolyte layer (014). A second composite anode layer with a lower anolyte mass percentage (048) is formed onto said first composite anode layer (050). A third composite anode layer with an even lower anolyte mass percentage (046) is formed onto said second composite anode layer (048). Said third composite anode layer (046) is laminated with a negative current collector (028).

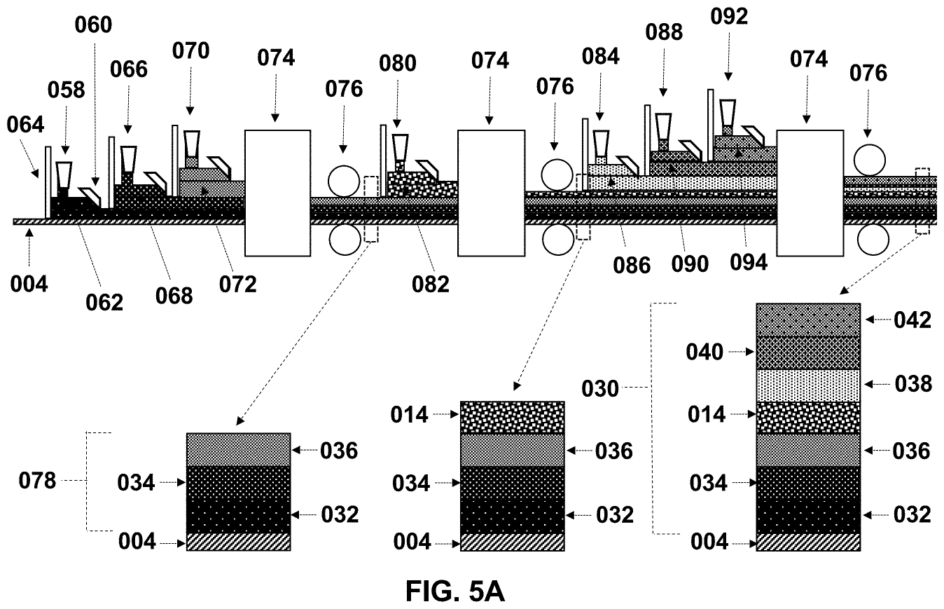

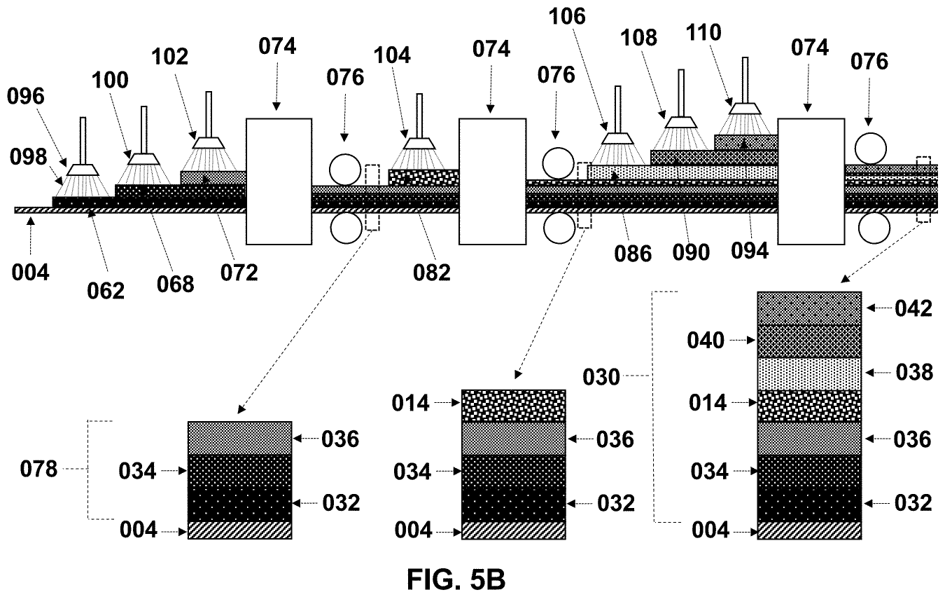

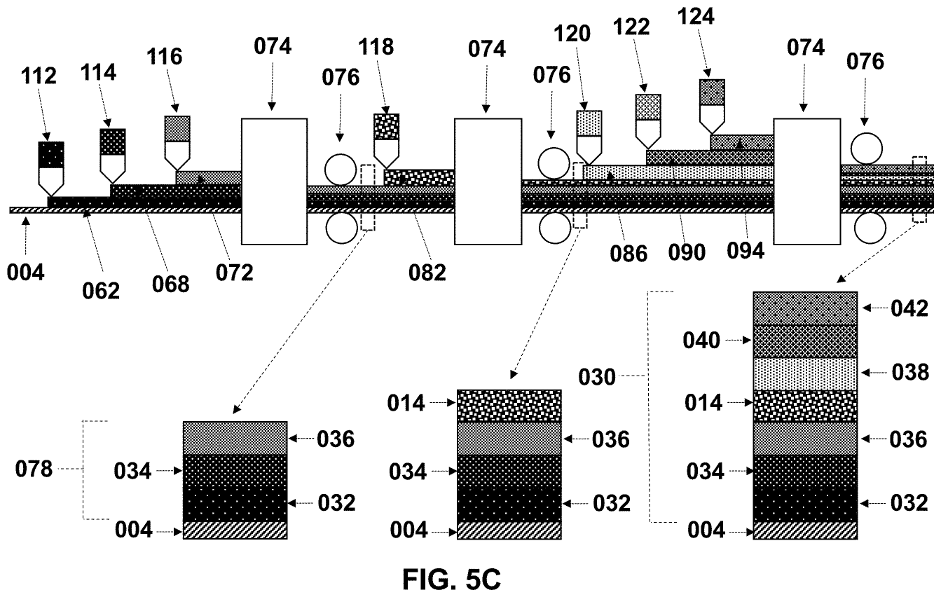

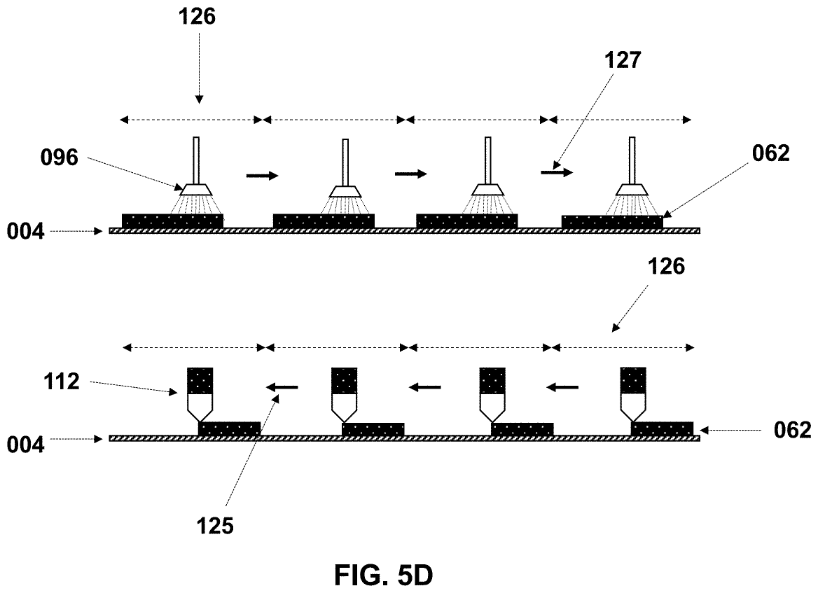

FIG. 5A: A schematic illustration of a roll-to-roll solvent-based manufacturing method using a tape casting approach to construct a gradient solid-state battery layer (030). A first composite cathode slurry layer (062) is formed onto a positive current collector (004), wherein the slurry is deposited from a first composite cathode slurry feeder (058). Layer thickness is controlled using a doctor blade (060) and a slurry blocking wall (064) is used to prevent spillage of the first composite cathode slurry. The process is repeated to form a gradient solid-state battery layer (030). A second composite cathode slurry layer (068) is formed onto a first composite cathode slurry layer (062) using a second composite cathode slurry feeder (066). A third composite cathode slurry layer (072) is formed onto a second composite cathode slurry layer (068) using a third composite cathode slurry feeder (070). Composite cathode layers are dried and calendered using a drying (074) and hot calendered (076) to form a catholyte gradient composite cathode structure (078) consisting of a first composite cathode layer with a low catholyte mass percentage (032), a second composite cathode layer with a higher catholyte mass percentage (034), and a third composite cathode layer with an even higher catholyte mass percentage (036). A solid-state electrolyte slurry layer (082) is formed onto the catholyte gradient composite cathode structure (078) using a solid-state electrolyte slurry feeder (080). A solid-state electrolyte slurry layer (082) is dried and calendered using a drying (074) and hot calendered (076) system to form a solid-state electrolyte layer (014). A first composite anode slurry layer (086) is formed onto a solid-state electrolyte layer (014) using a first composite anode slurry feeder (084). A second composite anode slurry layer (090) is formed onto a first composite anode slurry layer (086) using a second composite anode slurry feeder (088). A third composite anode slurry layer (094) is formed onto a second composite anode slurry layer (088) using a third composite anode slurry feeder (092). Composite anode layers are dried and calendered using a drying (074) and hot calendered (076) to form an anolyte gradient composite anode structure consisting of a first composite anode layer with a high anolyte mass percentage (038), a second composite anode layer with a lower anolyte mass percentage (040), and a third composite anode layer with an even anolyte mass percentage (042), forming the gradient solid-state battery layer (030). Alternatively, the tape casting process may be used to form a gradient solid-state battery layer (030) onto a negative current collector, wherein a first composite anode layer with a low anolyte mass percentage is formed first.

FIG. 5B: A schematic illustration of a roll-to-roll solvent-based manufacturing method using a spraying approach to construct a gradient solid-state battery layer (030). A first composite cathode slurry layer (062) is sprayed onto a positive current collector (004), wherein a slurry is sprayed from a first composite cathode shower head (096). A first composite cathode slurry layer (062) is formed from a shower plum (098) out of the first composite cathode shower head (096). The process is repeated to form a gradient solid-state battery layer (030). A second composite cathode slurry layer (068) is sprayed onto a first composite cathode slurry layer (062) using a second composite cathode shower head (100). A third composite cathode slurry layer (072) is sprayed onto a second composite cathode slurry layer (068) using a third composite cathode shower head (102). Composite cathode layers are dried and calendered using a drying (074) and hot calendered (076) to form a gradient composite cathode structure (078) consisting of a first composite cathode layer with a low catholyte mass percentage (032), a second composite cathode layer with a higher catholyte mass percentage (034), and a third composite cathode layer with an even higher catholyte mass percentage (036). A solid-state electrolyte slurry layer (082) is sprayed onto the catholyte gradient composite cathode structure (078) using a solid-state electrolyte shower head (104). A solid-state electrolyte slurry layer (082) is dried and calendered using a drying (074) and hot calendered (076) system to form a solid-state electrolyte layer (014). A first composite anode slurry layer (086) is sprayed onto a solid-state electrolyte layer (014) using a first composite anode shower head (106). A second composite anode slurry layer (090) is sprayed onto a first composite anode slurry layer (086) using a second composite anode shower head (108). A third composite anode slurry layer (094) is sprayed onto a second composite anode slurry layer (088) using a third composite anode shower head (110). Composite anode layers are dried and calendered using a drying (074) and hot calendered (076) to form an anolyte gradient composite anode structure consisting of a first composite anode layer with a high anolyte mass percentage (038), a second composite anode layer with a lower anolyte mass percentage (040), and a third composite anode layer with an even anolyte mass percentage (042), forming the gradient solid-state battery layer (030). Alternatively, the spray process may be used to form a gradient solid-state battery layer (030) onto a negative current collector, wherein a first composite anode layer with a low anolyte mass percentage is sprayed first.

FIG. 5C: A schematic illustration of a roll-to-roll solvent-based manufacturing method using an ink jet printing approach to construct a gradient solid-state battery layer (030). A first composite cathode slurry layer (062) is printed onto a positive current collector (004) using a first composite cathode printing heading (112). The process is repeated to form a gradient solid-state battery layer (030). A second composite cathode slurry layer (068) is printed onto a first composite cathode slurry layer (062) using a second composite cathode printing head (114). A third composite cathode slurry layer (072) is printed onto a second composite cathode slurry layer (068) using a third composite cathode printing head (116). Composite cathode layers are dried and calendered using a drying (074) and hot calendered (076) to form a catholyte gradient composite cathode structure (078) consisting of a first composite cathode layer with a low catholyte mass percentage (032), a second composite cathode layer with a higher catholyte mass percentage (034), and a third composite cathode layer with an even higher catholyte mass percentage (036). A solid-state electrolyte slurry layer (082) is printed onto the catholyte gradient composite cathode structure (078) using a solid-state electrolyte printing head (118). A solid-state electrolyte slurry layer (082) is dried and calendered using a drying (074) and hot calendered (076) system to form a solid-state electrolyte layer (014). A first composite anode slurry layer (086) is printed onto a solid-state electrolyte layer (014) using a first composite anode printing head (106). A second composite anode slurry layer (090) is printed onto a first composite anode slurry layer (086) using a second composite anode printing head (108). A third composite anode slurry layer (094) is printed onto a second composite anode slurry layer (088) using a third composite anode printing head (110). Composite anode layers are dried and calendered using a drying (074) and hot calendered (076) to form an anolyte gradient composite anode structure consisting of a first composite anode layer with a high anolyte mass percentage (038), a second composite anode layer with a lower anolyte mass percentage (040), and a third composite anode layer with an even anolyte mass percentage (042), forming the gradient solid-state battery layer (030). Alternatively, the spray process may be used to form a gradient solid-state battery layer (030) onto a negative current collector, wherein a first composite anode layer with a low anolyte mass percentage is printed first.

FIG. 5D: A schematic illustration (top) of a spray process using more than one shower head to form a first composite cathode slurry layer (062) onto a positive current collector (004), wherein four first composite cathode shower heads (096) are moving in a raster formation to the right (127) through an automated or robotic process. First composite cathode shower heads (096) may move back and forth within a specified range (126) to form a first composite cathode slurry layer (062). This multi-shower automated process may be used for the second and third composite cathode layers, solid-state electrolyte layer, and first, second, and third composite anode layers to form a gradient solid-state battery layer. Alternatively, this process may be used to form a gradient solid-state battery layer onto a negative current collector, wherein a first composite anode layer with a low anolyte mass percentage is sprayed first. A schematic illustration (bottom) of an ink jet printing process using more than one printing heads to print a first composite cathode slurry layer (062) onto a positive current collector (004), wherein four first composite cathode printing heads (112) are moving in a raster formation to the left (125) through an automated or robotic process. First composite cathode printing heads (112) may move back and forth within a specified range (126) to form a first composite cathode slurry layer (062). This multi-head automated ink jet printing process may be used for the second and third composite cathode layers, solid-state electrolyte layer, and first, second, and third composite anode layers to print a gradient solid-state battery layer. Alternatively, this process may be used to form a gradient solid-state battery layer onto a negative current collector, wherein a first composite anode layer with a low anolyte mass percentage is printed first.

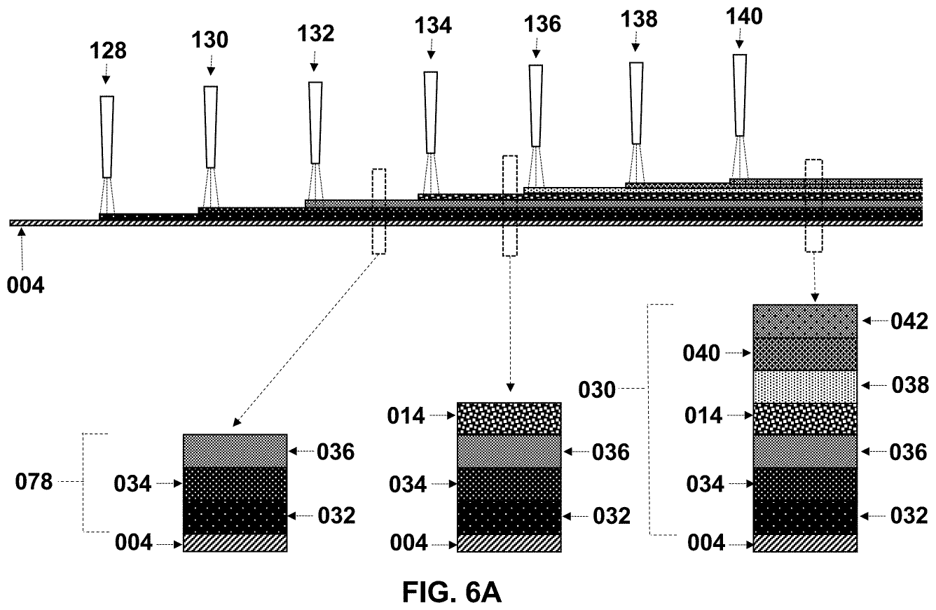

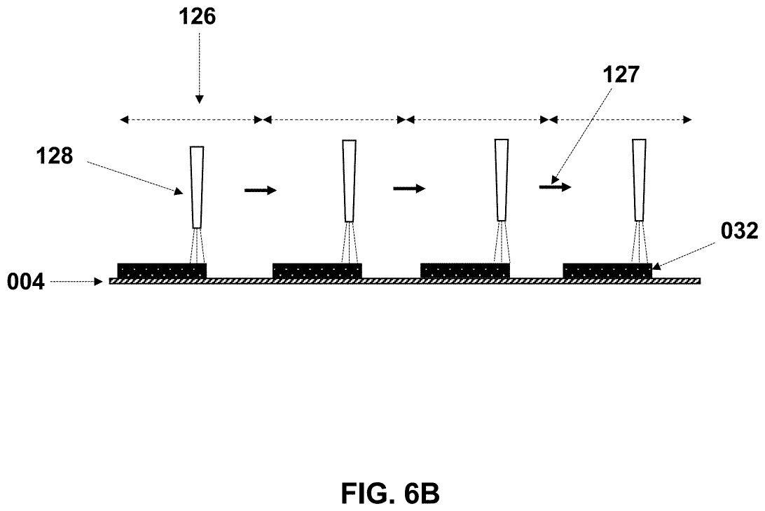

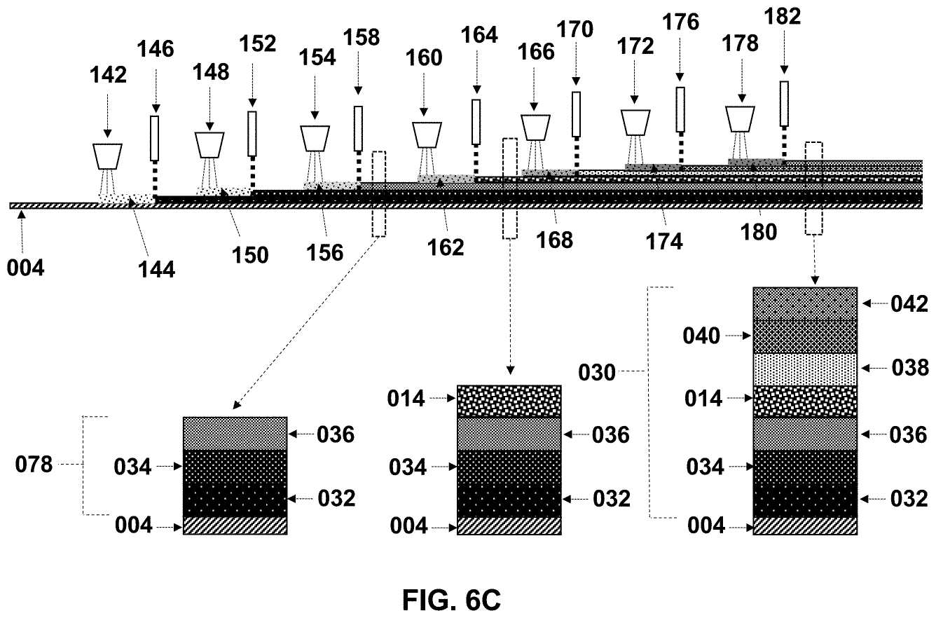

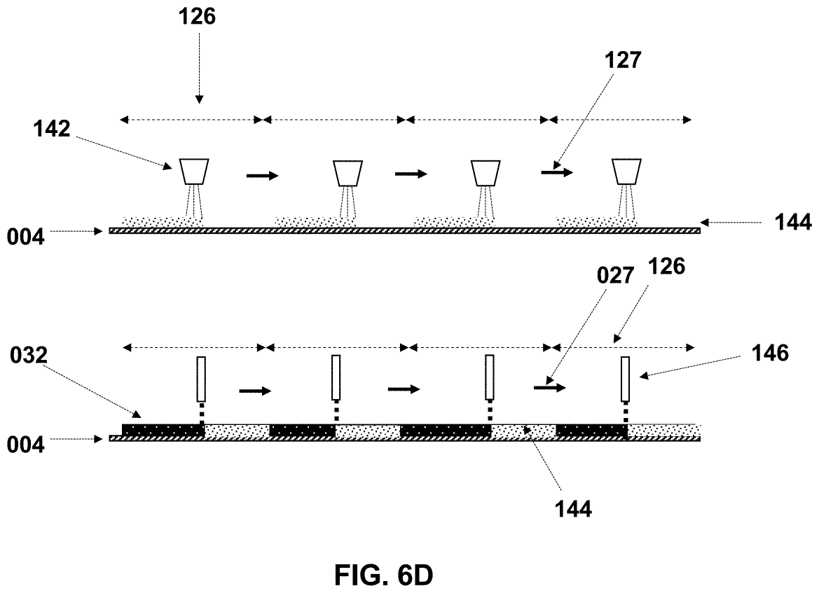

FIG. 6A: A schematic illustration of a roll-to-roll solvent-free manufacturing method using a cold or thermal spray approach to construct a gradient solid-state battery layer (030). A first dry composite cathode powder formulation is sprayed onto a positive current collector (004) using a first composite cathode spray gun (128), forming a first composite cathode layer with a low catholyte mass percentage (032). The process is repeated to form a gradient solid-state battery layer (030). A second dry composite cathode powder formulation is sprayed onto a first composite cathode layer (032) using a second composite cathode spray gun (130), forming a second composite cathode layer with a high catholyte mass percentage (034). A third dry composite cathode powder formulation is sprayed onto a second composite cathode layer (034) using a third composite cathode spray gun (132) to form a third composite cathode layer with an even higher catholyte mass percentage (036), forming a catholyte gradient composite cathode structure (078). A dry solid-state electrolyte powder formulation is sprayed onto a catholyte gradient composite cathode structure (087) using a solid-state electrolyte spray gun (130), forming a solid-state electrolyte layer (014). A first dry composite anode powder formulation is sprayed onto a solid-state electrolyte layer (014) using a first composite anode spray gun (136), forming a first composite anode layer with a high anolyte mass percentage (038). A second dry composite anode powder formulation is sprayed onto a first composite anode layer (038) using a first composite anode spray gun (138), forming a second composite anode layer with a lower anolyte mass percentage (040). A third dry composite anode powder formulation is sprayed onto a second composite anode layer (040) using a first composite anode spray gun (140) to form a third composite anode layer with an even lower anolyte mass percentage (042), forming a gradient solid-state battery layer (030). Alternatively, a cold or thermal spray process may be used to form a gradient solid-state battery layer (030) onto a negative current collector, wherein a first composite anode layer with a low anolyte mass percentage is sprayed first.

FIG. 6B: A schematic illustration of a cold or thermal spray process using more than one spray gun to form a first composite cathode layer (032) onto a positive current collector (004), wherein four first composite cathode spray guns (128) are moving in a raster formation to the right (127) through an automated or robotic process. First composite cathode spray guns (128) may move back and forth within a specified range (126) to form the first composite cathode layer (032). This multi-gun automated process may be used for the second and third composite cathode layers, solid-state electrolyte layer, and first, second, and third composite anode layers to form a gradient solid-state battery layer. Alternatively, this process may be used to form a gradient solid-state battery layer onto a negative current collector, wherein a first composite anode layer with a low anolyte mass percentage is sprayed first.

FIG. 6C: A schematic illustration of a roll-to-roll solvent-free manufacturing method using a laser assisted approach to construct a gradient solid-state battery layer (030). A first dry composite cathode powder formulation (144) is deposited onto a positive current collector (004) using a first composite cathode powder nozzle (142), wherein the powder nozzle may be part of a powder aerosol deposition system, an electrostatic spray deposition system, or a 3D printing system. A first composite cathode laser (146) is used to weld the materials making up the first dry composite cathode powder formulation (144) together, forming a first composite cathode layer with a low catholyte mass percentage (032). A second dry composite cathode powder formulation (150) is deposited onto a first composite cathode layer (032) using a second composite cathode powder nozzle (148). A second composite cathode laser (152) is used to weld the materials making up the second dry composite cathode powder formulation (150) together, forming a second composite cathode layer with a higher catholyte mass percentage (034). A third dry composite cathode powder formulation (156) is deposited onto a second composite cathode layer (034) using a third composite cathode powder nozzle (154). A third composite cathode laser (158) is used to weld the materials making up the third dry composite cathode powder formulation (156) together to form a third composite cathode layer with an even higher catholyte mass percentage (036), forming a catholyte gradient composite cathode structure (078). A dry solid-state electrolyte powder formulation (162) is deposited onto a catholyte gradient composite cathode structure (078) using a solid-state electrolyte powder nozzle (160). A solid-state electrolyte laser (164) is used to weld the materials making up the dry solid-state electrolyte powder formulation (162) together to form a solid-state electrolyte layer (014). A first dry composite anode powder formulation (168) is deposited onto a solid-state electrolyte layer (014) using a first composite anode powder nozzle (166). A first composite anode layer (170) is used to weld the materials making up the first dry composite anode powder formulation (168) together, forming a first composite anode layer with a high anolyte mass percentage (038). A second dry composite anode powder formulation (174) is deposited onto a first composite anode layer (038) using a second composite anode powder nozzle (172). A second composite anode laser (176) is used to weld the materials making up the second dry composite anode powder formulation (174) together, forming a second composite anode layer with a lower anolyte mass percentage (040). A third dry composite anode powder formulation (180) is deposited onto a second composite anode layer (040) using a third composite anode powder nozzle (178). A third composite anode laser (182) is used to weld the materials making up the third dry composite anode powder formulation (180) together to form a third composite anode layer with an even lower anolyte mass percentage (042), forming a gradient solid-state battery layer (030). Alternatively, a laser assisted approach may be used to form a gradient solid-state battery layer (030) onto a negative current collector, wherein a first composite anode layer with a low anolyte mass percentage is sprayed first.

FIG. 6D: A schematic illustration of a laser assisted process using more than one powder nozzle and laser to form a first composite cathode layer (032) onto a positive current collector (004), wherein four first composite cathode powder nozzles (142) and lasers (146) are moving in a raster formation to the right (127) through an automated or robotic process. First composite cathode powder nozzles (142) may move back and forth within a specified range (126) to form a layer comprising of first dry composite cathode powder formulation (144). Afterwards, first composite cathode lasers (146) may move back and forth within a specified range (126) to weld the materials of the first dry composite cathode powder formulation (144) to form a first composite cathode layer (032). This multi-laser assisted automated process may be used for the second and third composite cathode layers, solid-state electrolyte layer, and first, second, and third composite anode layers to form a gradient solid-state battery layer. Alternatively, this process may be used to form a gradient solid-state battery layer onto a negative current collector, wherein a first composite anode layer with a low anolyte mass percentage is sprayed first.

The above-described systems and methods can be ascribed to lithium-based secondary batteries such as, but not limited to, lithium-ion batteries, lithium metal batteries, all-solid-state lithium batteries, aqueous batteries, lithium polymer batteries, etc.

The above-described systems and methods can be ascribed to secondary batteries with chemistries beyond lithium, which may include sodium ion, aluminum ion, magnesium ion, iron ion, potassium ion, etc.

The above-described systems and methods can be ascribed to various secondary battery designs such as, but not limited to, pouch cell, coil cell, button cell, cylindrical cell, prismatic cell, etc.

The above-described systems and methods can be ascribed to secondary batteries with the end use applications such as, but not limited to, electric vehicles, hybrid electric vehicles, mobile devices, handheld electronics, consumer electronics, medical, medical wearables, and wearables for portable energy storage.

The above-described systems and methods can be ascribed to secondary batteries for grid scale energy storage backup systems.

The above-described systems and methods can be ascribed to secondary batteries for longevity, higher energy density and power density and improved safety.

The above-described systems and methods can be ascribed for alternative energy storage technologies such as primary batteries and flow batteries.

In the drawings, the following reference numbers are noted:
002 First composite cathode layer
004 Positive current collector
006 Active cathode materials
008 Catholyte
010 Second composite cathode layer
012 Third composite cathode layer
013 Catholyte gradient composite cathode structure
014 Solid-state electrolyte layer
016 Solid-state ionic conductive materials
018 First composite anode layer
020 Active anode materials
022 Anolyte
024 Second composite anode layer
026 Third composite anode layer
028 Negative current collector
029 Anolyte gradient composite anode structure
030 First solid-state battery layer
032 First composite cathode layer with a low catholyte mass percentage
034 Second composite cathode layer with a higher catholyte mass percentage
036 Third composite cathode layer with an even higher catholyte mass percentage
038 First composite anode layer with a high anolyte mass percentage
040 Second composite anode layer with a lower anolyte mass percentage
042 Third composite anode layer with an even lower anolyte mass percentage
044 Second solid-state battery layer
046 First composite anode layer with a low anolyte mass percentage
048 Second composite anode layer with a higher anolyte mass percentage
050 Third composite anode layer with an even higher anolyte mass percentage
052 First composite cathode layer with a high catholyte mass percentage
054 Second composite cathode layer with a lower catholyte mass percentage
056 Third composite cathode layer with an even lower catholyte mass percentage
058 First composite cathode slurry feeder
060 Doctor blade
062 First composite cathode slurry layer
064 Slurry blocking wall
066 Second composite cathode slurry feeder
068 Second composite cathode slurry layer
070 Third composite cathode slurry feeder
072 Third composite cathode slurry layer
074 Drying system
076 Hot calendering system
078 Catholyte gradient composite cathode structure
080 Solid-state electrolyte slurry feeder
082 Solid-state electrolyte slurry layer
084 First composite anode slurry feeder
086 First composite anode slurry layer
088 Second composite anode slurry feeder
090 Second composite anode slurry layer
092 Third composite anode slurry feeder
094 Third composite anode slurry layer
096 First composite cathode shower head
098 Shower plum
100 Second composite cathode shower head
102 Third composite cathode shower head
104 Solid-state electrolyte shower head
106 First composite anode shower head
108 Second composite anode shower head
110 Third composite anode shower head
112 First composite cathode printing head
114 Second composite cathode printing head
116 Third composite cathode printing head
118 Solid-state electrolyte printing head
120 First composite anode printing head
122 Second composite anode printing head
124 Third composite anode printing head
125 Raster direction to the left
126 Raster movement range
127 Raster direction to the right
128 First composite cathode spray gun
130 Second composite cathode spray gun
132 Third composite cathode spray gun
134 Solid-state electrolyte spray gun
136 First composite anode spray gun
138 Second composite anode spray gun
140 Third composite anode spray gun
142 First composite cathode powder nozzle
144 First dry composite cathode powder formulation
146 First composite cathode laser
148 Second composite cathode powder nozzle
150 Second dry composite cathode powder formulation
152 Second composite cathode laser
154 Third composite cathode powder nozzle
156 Third dry composite cathode powder formulation
158 Third composite cathode laser
160 Solid-state electrolyte powder nozzle
162 Dry solid-state electrolyte powder formulation
164 Solid-state electrolyte laser
166 First composite anode powder nozzle
168 First dry composite anode powder formulation
170 First composite anode laser
172 Second composite anode powder nozzle
174 Second dry composite anode powder formulation
176 Second composite anode laser
178 Third composite anode power nozzle
180 Third dry composite anode powder formulation
182 Third composite anode laser

Although various embodiments of the disclosed solid-state batteries, multilayer structures, and methods for manufacturing have been shown and described, modifications may occur to those skilled in the art upon reading the specification. The present application includes such modifications and is limited only by the scope of the claims.

What is claimed is:

1. A solid-state battery comprising:
a positive current collector;
a negative current collector;
a solid state electrolyte layer between the positive current collector and the negative current collector; and
at least one of a catholyte gradient composite cathode structure between the positive current collector and the solid state electrolyte layer and an anolyte gradient composite anode structure between the negative current collector and the solid state electrolyte layer.

2. The solid-state battery of claim 1, comprising the catholyte gradient composite cathode structure between the positive current collector.

3. The solid-state battery of claim 1, comprising the catholyte gradient composite cathode structure between the positive current collector and the solid state electrolyte layer, wherein a content of the catholyte proximate to the positive current collector is lower than a content of the catholyte proximate to the solid state electrolyte layer.

4. The solid-state battery of claim 1, comprising the anolyte gradient composite anode structure between the negative current collector and the solid state electrolyte layer.

5. The solid-state battery of claim 1, comprising the anolyte gradient composite anode structure between the negative current collector and the solid state electrolyte layer, wherein a content of the anolyte proximate to the negative current collector is lower than a content of the anolyte proximate to the solid state electrolyte layer.

6. The solid-state battery of claim 1, comprising the catholyte gradient composite cathode structure between the positive current collector and the anolyte gradient composite anode structure between the negative current collector and the solid state electrolyte layer.

7. A method for manufacturing a multilayer structure for a solid-state battery, the method comprising:
forming a first layer comprising a first catholyte or anolyte content; and
forming a second layer on the first layer, the second layer comprising a second catholyte or anolyte content, wherein the first catholyte or anolyte content is different from the second catholyte or anolyte content.

8. The method of claim 7, wherein the first and second layers are formed by a solvent-based method.

9. The method of claim 7, wherein the first and second layers are formed by a solvent-free method.

10. The method of claim 7, wherein the first and second layers are formed on a current collector.

11. The method of claim 7, wherein the first and second layers are formed on a solid state electrolyte layer.

12. A multilayer structure for a solid-state battery, the multilayer structure comprising:
a current collector; and
a plurality of layers comprising a catholyte or anolyte content, wherein the plurality of layers has a catholyte gradient or an anolyte gradient with respect to adjacent layers of the plurality of layers.

13. The multilayer structure of claim 12, wherein the plurality of layers comprises at least three layers.

14. The multilayer structure of claim 12, wherein a content of the anolyte or catholyte proximate to the current collector is lower than a content of the anolyte or catholyte farther from the current collector.

15. The multilayer structure of claim 12, further comprising a solid state electrolyte layer on the plurality of layers.

16. The multilayer structure of claim 12, the plurality of layers having the catholyte gradient, wherein the multilayer structure further comprises a solid state electrolyte layer on the plurality of layers and another plurality of layers having the anolyte gradient on the solid state electrolyte layer.

17. The multilayer structure of claim 12, the plurality of layers having the anolyte gradient, wherein the multilayer structure further comprises a solid state electrolyte layer on the plurality of layers and another plurality of layers having the catholyte gradient on the solid state electrolyte layer.
